(19) United States
(12) Patent Application Publication
(10) Pub. No.: US 2025/0381981 A1
(43) Pub. Date: Dec. 18, 2025

(54) TECHNIQUES FOR AUTONOMOUS DRIVING WITH LANGUAGE

(71) Applicant: NVIDIA CORPORATION, Santa Clara, CA (US)

(72) Inventors: Shihao WANG, Beijing (CN); Zhiding YU, Santa Clara, CA (US); Shiyi LAN, San Jose, CA (US); Min SHI, Wuhan City (CN); Jan KAUTZ, Lexington, MA (US); Jose Manuel ALVAREZ LOPEZ, Mountain View, CA (US)

(21) Appl. No.: 19/171,134

(22) Filed: Apr. 4, 2025

Related U.S. Application Data
(60) Provisional application No. 63/660,954, filed on Jun. 17, 2024.

(51) Int. Cl. B60W 60/00; G06T 7/73

(52) U.S. Cl. CPC B60W 60/001; G06T 7/73; B60W 2420/403; G06T 2200/04; G06T 2207/20081; G06T 2207/20084; G06T 2207/30241; G06T 2207/30252

(57) ABSTRACT

In various embodiments, a computer-implemented method for controlling a vehicle includes performing a visual-language alignment operation based on a set of multi-view image features and a three-dimensional position encoding to generate a set of aligned image features, causing a language model to generate a driving plan for operating the vehicle based on the set of aligned image features, wherein the driving plan includes a description of a three-dimensional trajectory for the vehicle; and controlling the vehicle to move based on the driving plan.

### CROSS-REFERENCE TO RELATED APPLICATIONS

This application claims priority benefit of the United States Provisional Patent Application titled, “TECHNIQUES FOR AUTONOMOUS DRIVING WITH LANGUAGE,” filed on Jun. 17, 2024 and having Ser. No. 63/660,954. The subject matter of this related application is hereby incorporated herein by reference.

### BACKGROUND

### Technical Field

Embodiments of the present disclosure relate generally to computer science, artificial intelligence (AI), machine learning, and autonomous vehicles and, more specifically, to techniques for autonomous driving with language.

### Description of the Related Art

Autonomous vehicles (AVs) are vehicles that can operate without human intervention. An AV system controls and navigates a vehicle using input from a combination of sensors and cameras that perceive the surrounding environment. AV systems rely on machine learning (ML) models to interpret data from the surrounding environment to make decisions such as steering, accelerating, braking, and responding to road conditions, traffic signs, and obstacles. One type of ML model commonly used in AV applications is a vision language model (VLM). A VLM configured for use in an AV processes visual data captured by cameras coupled to the AV and performs language-based reasoning regarding objects and situations expressed in the visual data. For example, the VLM could analyze a frame of video data depicting a stop sign, and then generate a text output indicating that the AV should stop at the stop sign. Incorporating language-based reasoning into AV control is advantageous because humans can readily understand language-based reasoning, thereby allowing the logical motivations behind specific driving decisions to be easily understood.

One drawback of the approach described above is that conventional VLMs are typically trained to operate using two-dimensional (2D) video data and, therefore, cannot perceive the full three-dimensional (3D) volume of space surrounding a given AV. Consequently, AV systems that rely on conventional VLMs cannot accurately assess distances, sizes, and/or relative positions of objects within the environment, and therefore cannot effectively make safe driving decisions. In addition, few, if any, large volumes of training data that include relevant annotations are currently available for training VLMs to perceive the 3D surroundings of a vehicle.

As the foregoing illustrates, what is needed in the art are more effective techniques for controlling autonomous vehicles.

### SUMMARY

In various embodiments, a computer-implemented method for controlling a vehicle includes performing a visual-language alignment operation based on a set of multi-view image features and a three-dimensional position encoding to generate a set of aligned image features, causing a language model to generate a driving plan for operating the vehicle based on the set of aligned image features, wherein the driving plan includes a description of a three-dimensional trajectory for the vehicle; and controlling the vehicle to move based on the driving plan.

At least one technical advantage of the disclosed techniques relative to the prior art is that, with the disclosed techniques, VLMs can be trained to interpret 3D image and position data similar to that commonly captured by sensor arrays on autonomous vehicles. Accordingly, VLMs configured to operate vehicles can assess the environment surrounding the vehicle with greater depth and accuracy, leading to safer driving decisions that better comply with traffic regulations. Another technical advantage of the disclosed techniques is that the disclosed data generation pipeline provides an efficient technique for generating the diverse training data needed to effectively train the projector to perform visual-language alignment using 3D input data. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the fine-tuning server of FIG. 1, according to various embodiments;

FIG. 3 is a more detailed illustration of the computing device of FIG. 1, according to various embodiments;

FIG. 4A is an illustration of an exemplar autonomous vehicle, according to various embodiments;

FIG. 4B illustrates exemplar camera locations and fields of view for the exemplar autonomous vehicle of FIG. 4A, according to various embodiments

FIG. 4C is a block diagram of an exemplar system architecture for the exemplar autonomous vehicle of FIG. 4A, according to various embodiments;

FIG. 4D is a system diagram for communication between cloud-based server(s) and the exemplar autonomous vehicle of FIG. 4A, according to various embodiments

FIG. 5A is an illustration of a first portion of the data generation pipeline of FIG. 1, according to various embodiments;

FIG. 5B is an illustration of a second portion of the data generation pipeline of FIG. 1, according to various embodiments;

FIG. 6 is a more detailed illustration of the training data of FIG. 1, according to various embodiments;

FIG. 7 is a flow diagram of method steps for generating training data for training a vision language model (VLM), according to various embodiments;

FIG. 8 is a more detailed illustration of the re-trained VLM of FIG. 1, according to various embodiments;

FIG. 9A is a more detailed illustration of the Omni-Q projector of FIG. 8, according to various embodiments;

FIG. 9B is a more detailed illustration of the Omni-L projector of FIG. 8, according to various embodiments; and

FIG. 10 is a flow diagram of method steps for generating a driving plan for an autonomous vehicle, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for controlling an autonomous vehicle (AV) using a vision-language model (VLM) trained to interpret three-dimensional (3D) data. The VLM includes a projector that is configured to process multi-view image features and a 3D position encoding to generate aligned image features. One or more large-language models (LLMs) are configured to process the aligned image features in order to generate a driving plan for controlling the AV. In some embodiments, one implementation of the projector includes a hybrid attention module that processes carrier and perception queries to exchange information between such queries, and a cross attention module that permits the carrier and perception queries to collect information from multi-view images. The cross attention module processes a value, key, and query that include multi-view image features, a combination of the 3D position encoding and the multi-view image features, and an output of the hybrid attention module, respectively. Perception queries output by the cross attention module are used to predict perception results including the categories and/or coordinates of foreground elements, such as bounding boxes or lane center lines. An LLM processes visual tokens generated by projecting carrier queries output by the cross attention module to generate the driving plan. In some other embodiments, an alternative implementation of the projector includes one or more linear input layers, one or more Gaussian Error Linear Units (GELUs), and one or more linear output layers, forming an MLP. In this implementation, the MLP processes the multi-view image features and 3D position data to align visual and language embedding spaces and outputs tokens that an LLM then processes to generate the driving plan. In either implementation, the VLM can be trained using annotated image data that is generated via a data generation pipeline.

In various embodiments, the disclosed data generation pipeline includes at least two phases of data generation. In a first phase of data generation, an image encoder encodes annotated image data derived from a dataset for autonomous driving that includes multi-sensor data collected from real-world driving scenarios (e.g., the nuScenes dataset) to extract semantic features. A semantic clustering module performs a clustering operation based on the semantic features to extract a set of key frames that include a diverse collection of different driving situations. A trajectory clustering module then performs another clustering operation to identify a subset of the key frames that include a diverse collection of different driving trajectories. The resultant key frames include images and corresponding annotations that represent both diverse driving situations and diverse trajectories. The annotations include metadata derived from the dataset for autonomous driving, including object labels, bounding boxes, trajectories, hierarchical object topologies, and other language descriptions of features included in the corresponding images. In a second phase of data generation, a counterfactual checklist module validates the set of key frames output by the first phase of data generation. The counterfactual checklist module applies a set of rules to determine whether the driving behavior set forth in the key frames adheres to driving and safety regulations. A prompt designer then evaluates the key frames and generates captions and one or more simulated trajectories and driving decisions for each image. A given caption describes the features of the image in detail. A given trajectory includes a set of points along which the vehicle travels. A given driving decision explains the rationale behind causing the vehicle to follow a corresponding trajectory. The prompt design module generates a set of prompts based on the captions, trajectories, and driving decisions. A conversation generator then generates a set of conversations that include question and answer (Q&A) dialogues related to different aspects of driving. The conversation generator generates Q&A dialogues related to scene descriptions, object attention, counterfactual reasoning, decision making and planning, and other areas where logical reasoning is applied during driving. The annotated image data, in combination with the prompts generated via the prompt designer and the Q&A dialogues generated via the conversation generator, form the training data. The training data is used to train and/or fine-tune the VLM described above.

The techniques for controlling vehicles using a VLM configured to interpret 3D data have many real-world applications. For example, those techniques could be used to control autonomous or semiautonomous vehicles within real-world or virtual environments. Further, the disclosed techniques could be applied in situations where human users review and/or analyze the logic implemented when the VLM makes a given driving decision.

The above examples are not in any way intended to be limiting. As persons skilled in the art will appreciate, as a general matter, the techniques for controlling vehicles described herein can be implemented in any suitable application.

### System Overview

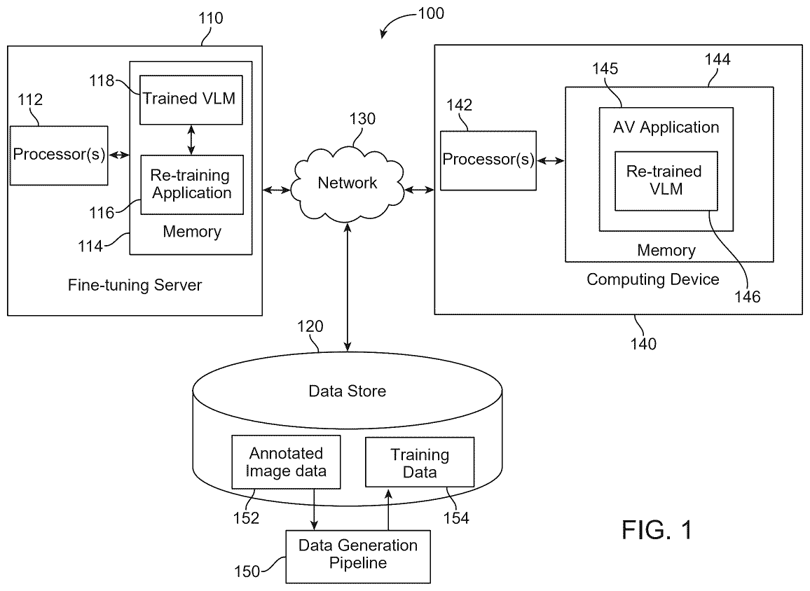

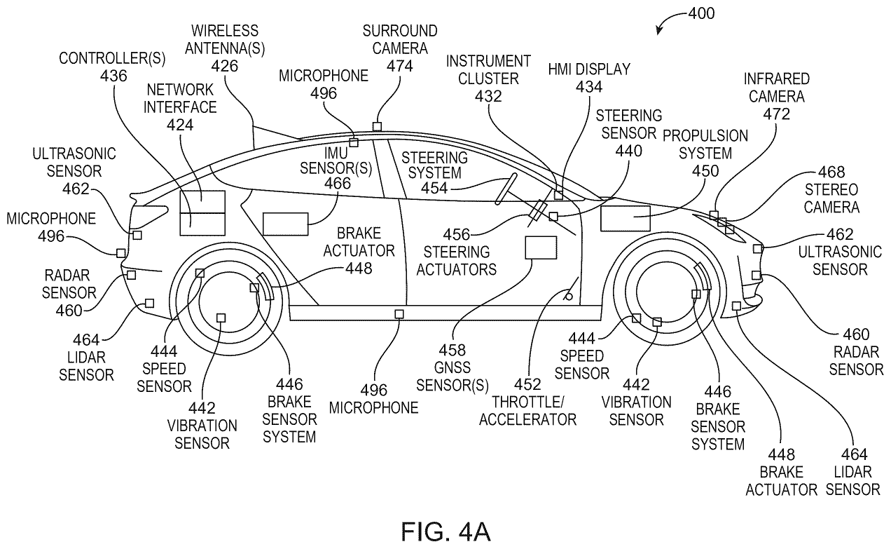

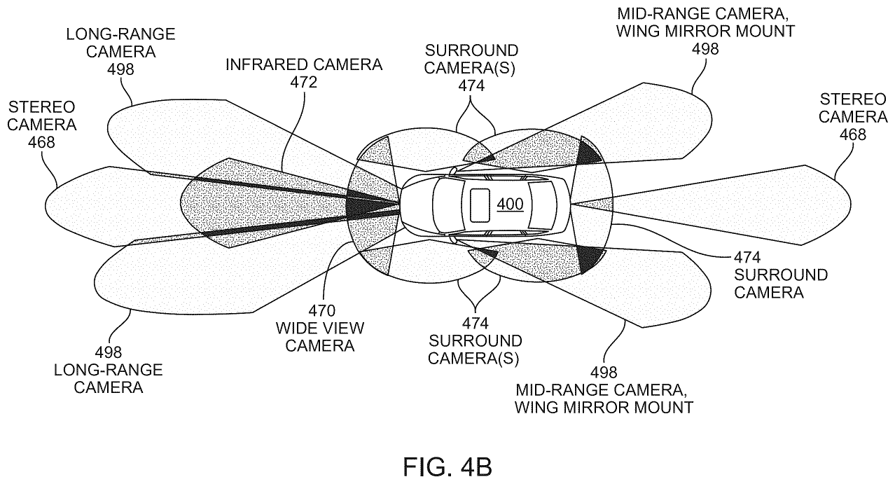

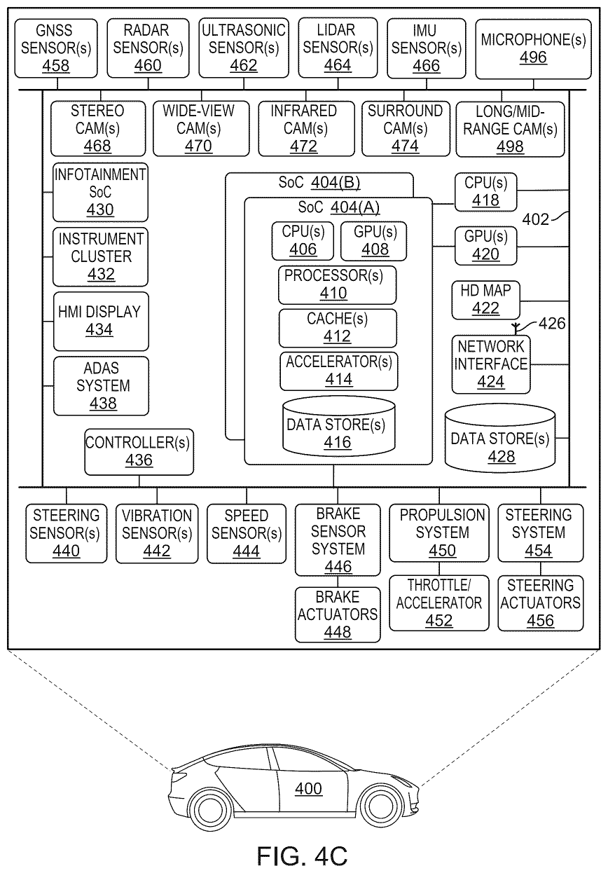

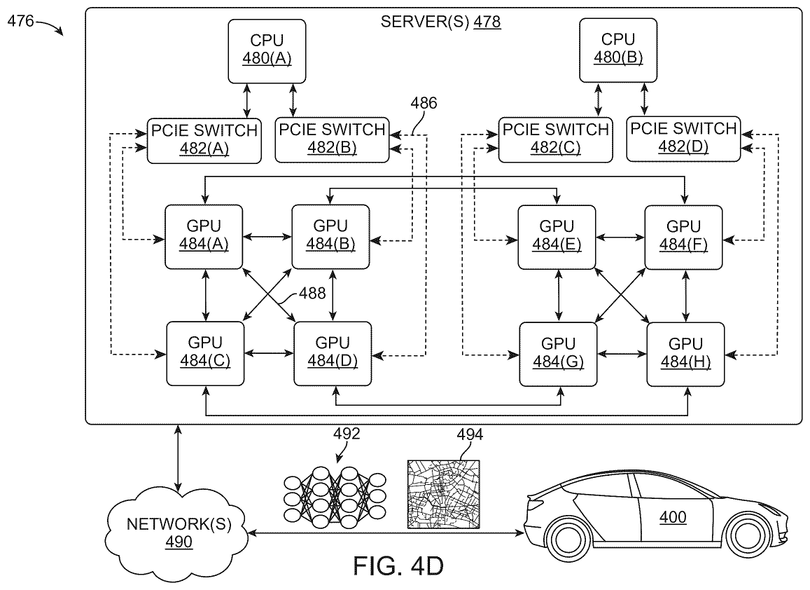

FIG. 1 illustrates a block diagram of a computer-based system 100 configured to implement one or more aspects of the various embodiments. As shown, system 100 includes, without limitation, a fine-tuning server 110, a data store 120, a network 130, and a computing device 140. Fine-tuning server 110 includes, without limitation, processor(s) 112 and a system memory 114. Memory 114 includes, without limitation, a re-training application 116 and a trained vision-language model (VLM) 118. Computing device 140 includes, without limitation, processor(s) 142 and memory 144. Memory 144 includes, without limitation, an AV application 145 which includes a re-trained VLM 146. Data store 120 includes, without limitation, auxiliary tools 122, human-annotated labels 132, and generated labels 134. In some embodiments, computing device 140 can be included in an autonomous vehicle, as described in greater detail below in conjunction with FIGS. 4A-4D.

Fine-tuning server 110 shown herein is for illustrative purposes only, and variations and modifications are possible without departing from the scope of the present disclosure. For example, the number and types of processors 112, the number and types of system memories 114, and/or the number of applications included in the system memory 114 can be modified as desired. Further, the connection topology between the various units in FIG. 1 can be modified as desired. In some embodiments, any combination of the processor(s) 112 and the system memory 114 can be included in and/or replaced with any type of virtual computing system, distributed computing system, and/or cloud computing environment, such as a public, private, or a hybrid cloud system.

Processor(s) 112 receive user input from input devices, such as a keyboard or a mouse. Processor(s) 112 can be any technically feasible form of processing device configured to process data and execute program code. For example, any of processor(s) 112 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 112, or any combination of these different processors, such as a CPU working in cooperation with a one or more GPUs. In various embodiments, the one or more GPU(s) perform parallel processing tasks, such as VLM 118 computations. Processor(s) 112 can also receive user input from input devices, such as a keyboard or a mouse and generate output on one or more displays.

System memory 114 of fine-tuning server 110 stores content, such as software applications and data, for use by processor(s) 112. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

Re-training application 116 is configured to re-train a trained vision-language model (VLM), such as trained VLM 118, using any technically feasible form of labeled or unlabeled training data. In some embodiments, re-training application 116 can receive vehicle sensor data and generate labels for training data using auxiliary tools 122.

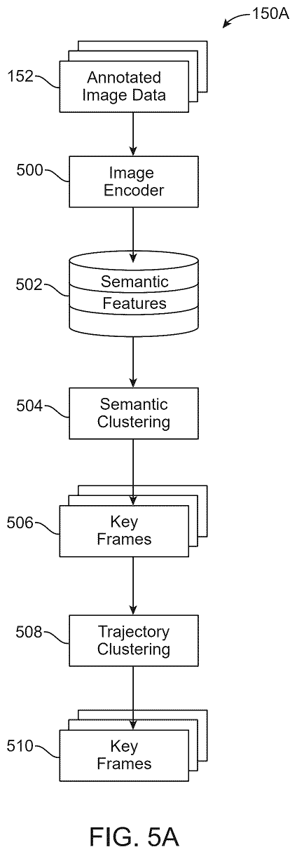

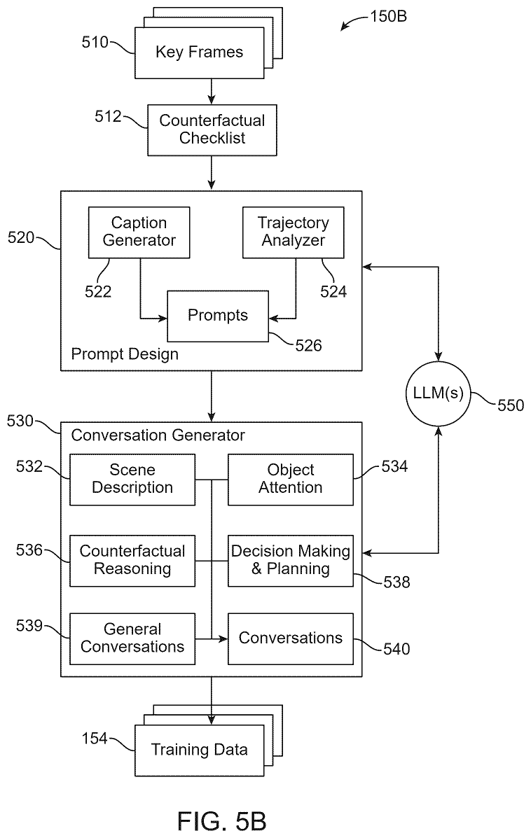

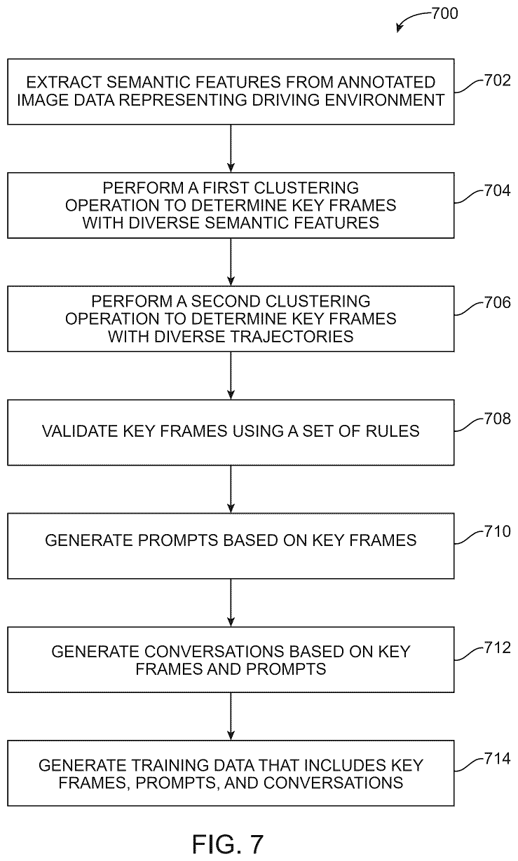

Trained VLM 118 can be any type of technically feasible machine learning model. For example, in various embodiments, trained VLM 118 can be a transformer-based VLM, such as a LLaMA (Large Language Model Meta AI) model, with a generative model architecture. The operations performed by re-training application 116 to re-train the trained VLM 118 are described in greater detail below in conjunction with FIGS. 5 and 7.

Data store 120 provides non-volatile storage for applications and data in fine-tuning server 110 and computing device 140. For example, and without limitation, training data, trained (or deployed) machine learning models and/or application data, including trained VLM 118, human-annotated labels 132, and generated labels 134, can be stored in the data store 120. In some embodiments, data store 120 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 120 can be a network attached storage (NAS) and/or a storage area-network (SAN). Although shown as coupled to fine-tuning server 110 and computing device 140 via network 130, in various embodiments, fine-tuning server 110 or computing device 140 can include data store 120.

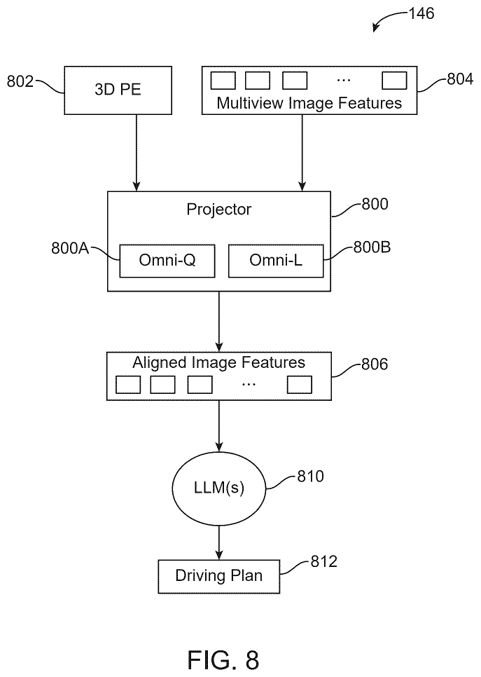

As further shown, data store 120 includes annotated image data 152 and training data 154. In various embodiments, a data generation pipeline 150 is configured to process annotated image data 152 to generate training data 154. Data generation pipeline 150 is described in greater detail below in conjunction with FIGS. 5A-7. Training data 154 can be implemented to train and/or fine tune trained VLM 118 and/or re-trained VLM 146. Re-trained VLM is described in greater detail below in conjunction with FIGS. 8-10.

Network 130 includes any technically feasible type of communications network that allows data to be exchanged between fine-tuning server 110, computing device 140, data store 120 and external entities or devices, such as a web server or another networked computing device. For example, network 130 can include a wide area network (WAN), a local area network (LAN), a cellular network, a wireless (WiFi) network, and/or the Internet, among others.

Computing device 140 shown herein is for illustrative purposes only, and variations and modifications are possible without departing from the scope of the present disclosure. For example, the number and types of processors 142, the number and types of system memories 144, and/or the number of applications included in the system memory 144 can be modified as desired. Further, the connection topology between the various units in FIG. 1 can be modified as desired. In some embodiments, any combination of the processor(s) 142 and/or the system memory 144 can be included in and/or replaced with any type of virtual computing system, distributed computing system, and/or cloud computing environment, such as a public, private, or a hybrid cloud system.

Processor(s) 142 of computer device 140 receive user input from input devices, such as a keyboard or a mouse. Processor(s) 142 can be any technically feasible form of processing device configured to process data and execute program code. For example, any of processor(s) 142 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 142, or any combination of these different processors, such as a CPU working in cooperation with a one or more GPUs. In various embodiments, the one or more GPU(s) perform parallel processing task, such as VLM computations. Processor(s) 142 can also receive user input from input devices, such as a keyboard or a mouse and generate output on one or more displays.

Similar to memory 114 of fine-tuning server 110, memory 144 of computing device 140 stores content, such as software applications and data, for use by the processor(s) 142. System memory 144 can be any type of memory capable of storing data and software applications, such as a RAM, ROM, EPROM, Flash ROM, or any suitable combination of the foregoing. In some embodiments, a storage (not shown) can supplement or replace the system memory 144. The storage can include any number and type of external memories that are accessible to processor 142. For example, and without limitation, the storage can include a Secure Digital Card, an external Flash memory, a portable CD-ROM, an optical storage device, a magnetic storage device, and/or any suitable combination of the foregoing.

To control a vehicle, AV application 145 receives sensor data. Given the sensor data, AV application 145 generates a plan for the vehicle to follow using re-trained VLM 146. AV application 145 controls the vehicle to steer, accelerate, and/or brake according to the plan. Re-trained VLM 146 can be any type of technically feasible machine learning model that is able to process text and images simultaneously to perform visual-language tasks, such as visual question answering, image captioning, and/or text-to-image search. For example, in various embodiments, re-trained VLM 146 can be a transformer-based VLM with any suitable architecture.

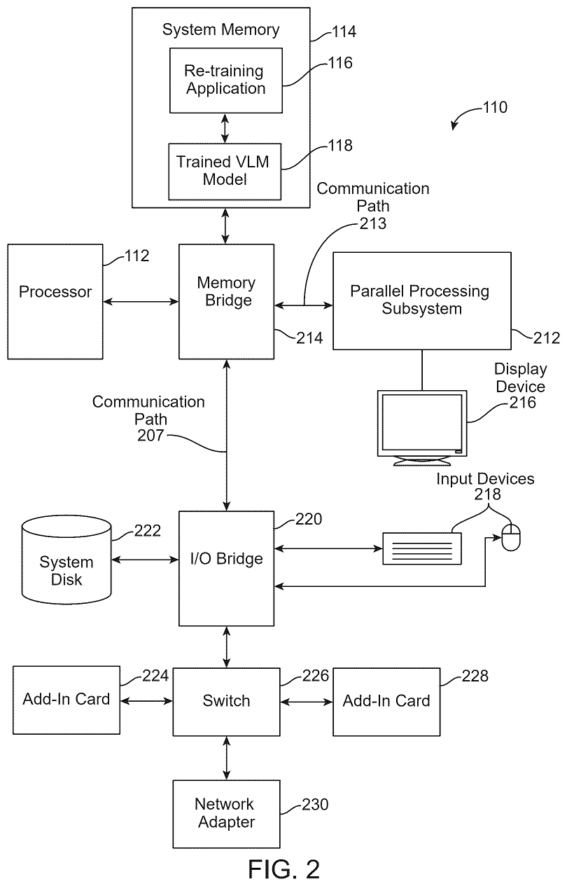

FIG. 2 is a more detailed illustration of fine-tuning server 110 of FIG. 1, according to various embodiments. As persons skilled in the art will appreciate, fine-tuning server 110 can be any type of technically feasible computer system, including, without limitation, a server machine, a server platform, a desktop machine, laptop machine, a hand-held/mobile device, or a wearable device. In some embodiments, fine-tuning server 110 is a server machine operating in a data center or a cloud computing environment that provides scalable computing resources as a service over a network.

In various embodiments, fine-tuning server 110 includes, without limitation, a processor 112 and a memory 114 coupled to a parallel processing subsystem 212 via a memory bridge 214 and a communication path 213. Memory bridge 214 is further coupled to an I/O (input/output) bridge 220 via a communication path 207, and I/O bridge 220 is, in turn, coupled to a switch 226.

In some embodiments, I/O bridge 220 is configured to receive user input information from optional input devices 218, such as a keyboard or a mouse, and forward the input information to processor 112 for processing via communication path 213 and memory bridge 214. In some embodiments, fine-tuning server 110 may be a server machine in a cloud computing environment. In such embodiments, fine-tuning server 110 may not have input devices 218. Instead, fine-tuning server 110 may receive equivalent input information by receiving commands in the form of messages transmitted over a network and received via network adapter 230. In some embodiments, switch 226 is configured to provide connections between I/O bridge 220 and other components of fine-tuning server 110, such as a network adapter 230 and various add-in cards 224 and 228.

In some embodiments, I/O bridge 220 is coupled to a system disk 222 that may be configured to store content and applications and data for use by processor 112 and parallel processing subsystem 212. In some embodiments, system disk 222 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 220 as well.

In various embodiments, memory bridge 214 may be a Northbridge chip, and I/O bridge 220 may be a Southbridge chip. In addition, communication paths 213 and 207, as well as other communication paths within fine-tuning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 216 that may be any conventional cathode ray tube, liquid crystal display, light-emitting diode display, or the like. In such embodiments, parallel processing subsystem 212 incorporates circuitry optimized for graphics and video processing, including, for example, video output circuitry. Such circuitry may be incorporated across one or more parallel processing units (PPUs), also referred to herein as parallel processors, included within parallel processing subsystem 212. In other embodiments, parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 114 includes at least one device driver configured to manage the processing operations of the one or more PPUs within parallel processing subsystem 212.

In addition, system memory 114 includes re-training application 116 and trained VLM 118. As described, re-training application 116 is configured to re-train a trained VLM, such as trained VLM 118, using training data. Although described herein primarily with respect to re-training application 116, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2 to form a single system. For example, parallel processing subsystem 212 may be integrated with processor 112 and other connection circuitry on a single chip to form a system on chip (SoC).

In some embodiments, processor 112 is the master processor of fine-tuning server 110, controlling and coordinating operations of other system components. In some embodiments, processor 112 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 112, and the number of parallel processing subsystems 212, may be modified as desired. For example, in some embodiments, system memory 114 could be connected to processor 112 directly rather than through memory bridge 214, and other devices would communicate with system memory 114 via memory bridge 214 and processor 112. In other embodiments, parallel processing subsystem 212 may be connected to I/O bridge 220 or directly to processor 112, rather than to memory bridge 214. In still other embodiments, I/O bridge 220 and memory bridge 214 may be integrated into a single chip instead of existing as one or more discrete devices. In certain embodiments, one or more components shown in FIG. 2 may not be present. For example, switch 226 could be eliminated, and network adapter 230 and add-in cards 224, 228 would connect directly to I/O bridge 220. Lastly, in certain embodiments, one or more components shown in FIG. 2 may be implemented as virtualized resources in a virtual computing environment, such as a cloud computing environment. In particular, parallel processing subsystem 212 may be implemented as a virtualized parallel processing subsystem in some embodiments. For example, parallel processing subsystem 212 could be implemented as a virtual graphics processing unit (GPU) that renders graphics on a virtual machine (VM) executing on a server machine whose GPU and other physical resources are shared across multiple VMs.

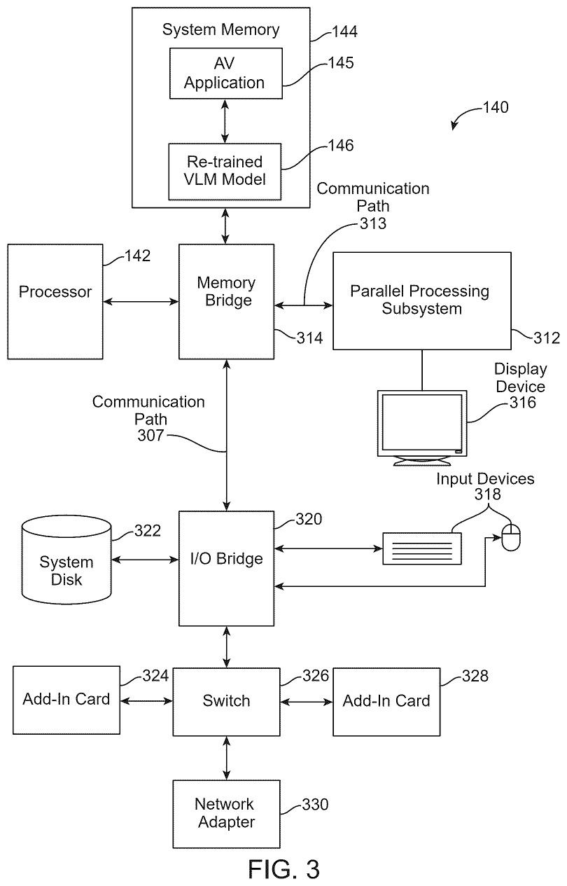

FIG. 3 is a more detailed illustration of computing device 140 of FIG. 1, according to various embodiments. As persons skilled in the art will appreciate, computing device 140 can be any type of technically feasible computer system, including, without limitation, a server machine, a server platform, a desktop machine, laptop machine, a hand-held/mobile device, or a wearable device. In some embodiments, computing device 140 is a server machine operating in a data center or a cloud computing environment that provides scalable computing resources as a service over a network.

In various embodiments, computing device 140 includes, without limitation, a processor 142 and a memory 144 coupled to a parallel processing subsystem 312 via a memory bridge 314 and a communication path 313. Memory bridge 314 is further coupled to an I/O (input/output) bridge 320 via a communication path 307, and I/O bridge 220 is, in turn, coupled to a switch 326.

In some embodiments, I/O bridge 320 is configured to receive user input information from optional input devices 318, such as a keyboard or a mouse, and forward the input information to processor 142 for processing via communication path 313 and memory bridge 314. In some embodiments, computing device 140 may be a server machine in a cloud computing environment. In such embodiments, computing device 140 may not have input devices 318. Instead, computing device 140 may receive equivalent input information by receiving commands in the form of messages transmitted over a network and received via network adapter 330. In some embodiments, switch 326 is configured to provide connections between I/O bridge 320 and other components of computing device 140, such as a network adapter 330 and various add-in cards 324 and 328.

In some embodiments, I/O bridge 320 is coupled to a system disk 322 that may be configured to store content and applications and data for use by processor 142 and parallel processing subsystem 312. In some embodiments, system disk 322 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 320 as well.

In various embodiments, memory bridge 314 may be a Northbridge chip, and I/O bridge 320 may be a Southbridge chip. In addition, communication paths 313 and 207, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 316 that may be any conventional cathode ray tube, liquid crystal display, light-emitting diode display, or the like. In such embodiments, parallel processing subsystem 312 incorporates circuitry optimized for graphics and video processing, including, for example, video output circuitry. Such circuitry may be incorporated across one or more parallel processing units (PPUs), also referred to herein as parallel processors, included within parallel processing subsystem 312. In other embodiments, parallel processing subsystem 312 incorporates circuitry optimized for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and compute processing operations. System memory 144 includes at least one device driver configured to manage the processing operations of the one or more PPUs within parallel processing subsystem 312.

In addition, system memory 144 includes AV application 145 and re-trained VLM 146. In some embodiments, AV application 145 receives sensor data, generates a plan for a vehicle (e.g., the autonomous vehicle 400 described below in conjunction with FIGS. 4A-4D) to follow, and uses re-trained VLM 146 to control a vehicle. AV application 145 controls the vehicle to steer, accelerate, and/or brake according to the plan. Although described herein primarily with respect to AV application 145, techniques disclosed herein can also be implemented, either entirely or in part, in other software and/or hardware, such as in parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on chip (SoC).

In some embodiments, processor 142 is the master processor of computing device 140, controlling and coordinating operations of other system components. In some embodiments, processor 142 issues commands that control the operation of PPUs. In some embodiments, communication path 313 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 142, and the number of parallel processing subsystems 312, may be modified as desired. For example, in some embodiments, system memory 144 could be connected to processor 142 directly rather than through memory bridge 314, and other devices would communicate with system memory 144 via memory bridge 314 and processor 142. In other embodiments, parallel processing subsystem 312 may be connected to I/O bridge 320 or directly to processor 142, rather than to memory bridge 314. In still other embodiments, I/O bridge 320 and memory bridge 314 may be integrated into a single chip instead of existing as one or more discrete devices. In certain embodiments, one or more components shown in FIG. 3 may not be present. For example, switch 326 could be eliminated, and network adapter 330 and add-in cards 324, 328 would connect directly to I/O bridge 320. Lastly, in certain embodiments, one or more components shown in FIG. 3 may be implemented as virtualized resources in a virtual computing environment, such as a cloud computing environment. In particular, parallel processing subsystem 312 may be implemented as a virtualized parallel processing subsystem in some embodiments. For example, parallel processing subsystem 312 could be implemented as a virtual graphics processing unit (GPU) that renders graphics on a virtual machine (VM) executing on a server machine whose GPU and other physical resources are shared across multiple VMs.

### Example Autonomous Vehicle

FIG. 4A is an illustration of an exemplar autonomous vehicle 400, according to various embodiments. The autonomous vehicle 400 (alternatively referred to herein as the “vehicle 400”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-401806, published on Jun. 15, 4018, Standard No. J3016-401609, published on Sep. 30, 4016, and previous and future versions of this standard). The vehicle 400 may be capable of functionality in accordance with one or more of Level 3-Level 5 of the autonomous driving levels. The vehicle 400 may be capable of functionality in accordance with one or more of Level 1-Level 5 of the autonomous driving levels. For example, the vehicle 400 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 400 or other machine, such as being fully autonomous, being highly autonomous, being conditionally autonomous, being partially autonomous, providing assistive autonomy, being semi-autonomous, being primarily autonomous, or other designation.

The vehicle 400 may include components such as a chassis, a vehicle body, wheels (e.g., 2, 4, 6, 8, 18, etc.), tires, axles, and other components of a vehicle. The vehicle 400 may include a propulsion system 450, such as an internal combustion engine, hybrid electric power plant, an all-electric engine, and/or another propulsion system type. The propulsion system 450 may be connected to a drive train of the vehicle 400, which may include a transmission, to enable the propulsion of the vehicle 400. The propulsion system 450 may be controlled in response to receiving signals from the throttle/accelerator 452.

A steering system 454, which may include a steering wheel, may be used to steer the vehicle 400 (e.g., along a desired path or route) when the propulsion system 450 is operating (e.g., when the vehicle is in motion). The steering system 454 may receive signals from a steering actuator 456. The steering wheel may be optional for full automation (Level 5) functionality.

The brake sensor system 446 may be used to operate the vehicle brakes in response to receiving signals from the brake actuators 448 and/or brake sensors.

Controller(s) 436, which may include one or more system on chips (SoCs) 404 (FIG. 4C) and/or GPU(s), may provide signals (e.g., representative of commands) to one or more components and/or systems of the vehicle 400. For example, the controller(s) may send signals to operate the vehicle brakes via one or more brake actuators 448, to operate the steering system 454 via one or more steering actuators 456, to operate the propulsion system 450 via one or more throttle/accelerators 452. The controller(s) 436 may include one or more onboard (e.g., integrated) computing devices (e.g., supercomputers) that process sensor signals, and output operation commands (e.g., signals representing commands) to enable autonomous driving and/or to assist a human driver in driving the vehicle 400. The controller(s) 436 may include a first controller 436 for autonomous driving functions, a second controller 436 for functional safety functions, a third controller 436 for artificial intelligence functionality (e.g., computer vision), a fourth controller 436 for infotainment functionality, a fifth controller 436 for redundancy in emergency conditions, and/or other controllers. In some examples, a single controller 436 may handle two or more of the above functionalities, two or more controllers 436 may handle a single functionality, and/or any combination thereof.

The controller(s) 436 may provide the signals for controlling one or more components and/or systems of the vehicle 400 in response to sensor data received from one or more sensors (e.g., sensor inputs). The sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LIDAR sensor(s) 464, inertial measurement unit (IMU) sensor(s) 466 (e.g., accelerometer(s), gyroscope(s), magnetic compass(es), magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range and/or mid-range camera(s) 498, speed sensor(s) 444 (e.g., for measuring the speed of the vehicle 400), vibration sensor(s) 442, steering sensor(s) 440, brake sensor(s) (e.g., as part of the brake sensor system 446), and/or other sensor types.

One or more of the controller(s) 436 may receive inputs (e.g., represented by input data) from an instrument cluster 432 of the vehicle 400 and provide outputs (e.g., represented by output data, display data, etc.) via a human-machine interface (HMI) display 434, an audible annunciator, a loudspeaker, and/or via other components of the vehicle 400. The outputs may include information such as vehicle velocity, speed, time, map data (e.g., the High Definition (“HD”) map 422 of FIG. 4C), location data (e.g., the vehicle's 400 location, such as on a map), direction, location of other vehicles (e.g., an occupancy grid), information about objects and status of objects as perceived by the controller(s) 436, etc. For example, the HMI display 434 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 400 further includes a network interface 424 which may use one or more wireless antenna(s) 426 and/or modem(s) to communicate over one or more networks. For example, the network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA4000”), etc. The wireless antenna(s) 426 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 4B illustrates exemplar camera locations and fields of view for the exemplar autonomous vehicle 400 of FIG. 4A, according to various embodiments. The cameras and respective fields of view are one example embodiment and are not intended to be limiting. For example, additional and/or alternative cameras may be included and/or the cameras may be located at different locations on the vehicle 400.

The camera types for the cameras may include, but are not limited to, digital cameras that may be adapted for use with the components and/or systems of the vehicle 400. The camera(s) may operate at automotive safety integrity level (ASIL) B and/or at another ASIL. The camera types may be capable of any image capture rate, such as 60 frames per second (fps), 120 fps, 440 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 400 (e.g., front-facing cameras) may be used for surround view, to help identify forward facing paths and obstacles, as well aid in, with the help of one or more controllers 436 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 470 that may be used to perceive objects coming into view from the periphery (e.g., pedestrians, crossing traffic or bicycles). Although only one wide-view camera is illustrated in FIG. 4B, there may be any number (including zero) of wide-view cameras 470 on the vehicle 400. In addition, any number of long-range camera(s) 498 (e.g., a long-view stereo camera pair) may be used for depth-based object detection, especially for objects for which a neural network has not yet been trained. The long-range camera(s) 498 may also be used for object detection and classification, as well as basic object tracking.

Any number of stereo cameras 468 may also be included in a front-facing configuration. In some embodiments, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 468 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 468 may be used in addition to, or alternatively from, those described herein.

Cameras with a field of view that include portions of the environment to the side of the vehicle 400 (e.g., side-view cameras) may be used for surround view, providing information used to create and update the occupancy grid, as well as to generate side impact collision warnings. For example, surround camera(s) 474 (e.g., four surround cameras 474 as illustrated in FIG. 4B) may be positioned on the vehicle 400. The surround camera(s) 474 may include wide-view camera(s) 470, fisheye camera(s), 360 degree camera(s), and/or the like. Four example, four fisheye cameras may be positioned on the vehicle's front, rear, and sides. In an alternative arrangement, the vehicle may use three surround camera(s) 474 (e.g., left, right, and rear), and may leverage one or more other camera(s) (e.g., a forward-facing camera) as a fourth surround view camera.

Cameras with a field of view that include portions of the environment to the rear of the vehicle 400 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 498, stereo camera(s) 468), infrared camera(s) 472, etc.), as described herein.

FIG. 4C is a block diagram of an exemplar system architecture for the exemplar autonomous vehicle 400 of FIG. 4A, according to various embodiments. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 400 in FIG. 4C are illustrated as being connected via bus 402. The bus 402 may include a Controller Area Network (CAN) data interface (alternatively referred to herein as a “CAN bus”). A CAN may be a network inside the vehicle 400 used to aid in control of various features and functionality of the vehicle 400, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 402 is described herein as being a CAN bus, this is not intended to be limiting. For example, in addition to, or alternatively from, the CAN bus, FlexRay and/or Ethernet may be used. Additionally, although a single line is used to represent the bus 402, this is not intended to be limiting. For example, there may be any number of busses 402, which may include one or more CAN busses, one or more FlexRay busses, one or more Ethernet busses, and/or one or more other types of busses using a different protocol. In some examples, two or more busses 402 may be used to perform different functions, and/or may be used for redundancy. For example, a first bus 402 may be used for collision avoidance functionality and a second bus 402 may be used for actuation control. In any example, each bus 402 may communicate with any of the components of the vehicle 400, and two or more busses 402 may communicate with the same components. In some examples, each SoC 404, each controller 436, and/or each computer within the vehicle may have access to the same input data (e.g., inputs from sensors of the vehicle 400), and may be connected to a common bus, such the CAN bus.

The vehicle 400 may include one or more controller(s) 436, such as those described herein with respect to FIG. 4A. The controller(s) 436 may be used for a variety of functions. The controller(s) 436 may be coupled to any of the various other components and systems of the vehicle 400, and may be used for control of the vehicle 400, artificial intelligence of the vehicle 400, infotainment for the vehicle 400, and/or the like.

The vehicle 400 may include a system(s) on a chip (SoC) 404. The SoC 404 may include CPU(s) 406, GPU(s) 408, processor(s) 410, cache(s) 412, accelerator(s) 414, data store(s) 416, and/or other components and features not illustrated. In some embodiments, components (e.g., CPU(s) 410 and data store(s) 416) included in the vehicle 400 can be the same as, or similar to, corresponding components (e.g., processor(s) 142 and memory (ies) 144) included in the computing system 140, described above in conjunction with FIG. 1. The SoC(s) 404 may be used to control the vehicle 400 in a variety of platforms and systems. For example, the SoC(s) 404 may be combined in a system (e.g., the system of the vehicle 400) with an HD map 422 which may obtain map refreshes and/or updates via a network interface 424 from one or more servers (e.g., server(s) 478 of FIG. 4D).

The CPU(s) 406 may include a CPU cluster or CPU complex (alternatively referred to herein as a “CCPLEX”). The CPU(s) 406 may include multiple cores and/or L2 caches. For example, in some embodiments, the CPU(s) 406 may include eight cores in a coherent multi-processor configuration. In some embodiments, the CPU(s) 406 may include four dual-core clusters where each cluster has a dedicated L2 cache (e.g., a 2 MB L2 cache). The CPU(s) 406 (e.g., the CCPLEX) may be configured to support simultaneous cluster operation enabling any combination of the clusters of the CPU(s) 406 to be active at any given time.

The CPU(s) 406 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 406 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 408 may include an integrated GPU (alternatively referred to herein as an “iGPU”). The GPU(s) 408 may be programmable and may be efficient for parallel workloads. The GPU(s) 408, in some examples, may use an enhanced tensor instruction set. The GPU(s) 408 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 408 may include at least eight streaming microprocessors. The GPU(s) 408 may use compute application programming interface(s) (API(s)). In addition, the GPU(s) 408 may use one or more parallel computing platforms and/or programming models (e.g., NVIDIA's CUDA).

The GPU(s) 408 may be power-optimized for best performance in automotive and embedded use cases. For example, the GPU(s) 408 may be fabricated on a Fin field-effect transistor (FinFET). However, this is not intended to be limiting and the GPU(s) 408 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 408 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 408 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 408 to access the CPU(s) 406 page tables directly. In such examples, when the GPU(s) 408 memory management unit (MMU) experiences a miss, an address translation request may be transmitted to the CPU(s) 406. In response, the CPU(s) 406 may look in its page tables for the virtual-to-physical mapping for the address and transmits the translation back to the GPU(s) 408. As such, unified memory technology may allow a single unified virtual address space for memory of both the CPU(s) 406 and the GPU(s) 408, thereby simplifying the GPU(s) 408 programming and porting of applications to the GPU(s) 408.

In addition, the GPU(s) 408 may include an access counter that may keep track of the frequency of access of the GPU(s) 408 to memory of other processors. The access counter may help ensure that memory pages are moved to the physical memory of the processor that is accessing the pages most frequently.

The SoC(s) 404 may include any number of cache(s) 412, including those described herein. For example, the cache(s) 412 may include an L3 cache that is available to both the CPU(s) 406 and the GPU(s) 408 (e.g., that is connected both the CPU(s) 406 and the GPU(s) 408). The cache(s) 412 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 404 may include an arithmetic logic unit(s) (ALU(s)) which may be leveraged in performing processing with respect to any of the variety of tasks or operations of the vehicle 400—such as processing DNNs. In addition, the SoC(s) 404 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 406 and/or GPU(s) 408.

The SoC(s) 404 may include one or more accelerators 414 (e.g., hardware accelerators, software accelerators, or a combination thereof). For example, the SoC(s) 404 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 408 and to off-load some of the tasks of the GPU(s) 408 (e.g., to free up more cycles of the GPU(s) 408 for performing other tasks). As an example, the accelerator(s) 414 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 414 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 408, and by using an inference accelerator, for example, a designer may target either the DLA(s) or the GPU(s) 408 for any function. For example, the designer may focus processing of CNNs and floating point operations on the DLA(s) and leave other functions to the GPU(s) 408 and/or other accelerator(s) 414.

The accelerator(s) 414 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 406. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 414 (e.g., the hardware acceleration cluster) may include a computer vision network on-chip and SRAM, for providing a high-bandwidth, low latency SRAM for the accelerator(s) 414. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 46262 or IEC 61508 standards, although other standards and protocols may be used.

In some examples, the SoC(s) 404 may include a real-time ray-tracing hardware accelerator, such as described in U.S. patent application Ser. No. 16/101,432, filed on Aug. 10, 4018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 414 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 466 output that correlates with the vehicle 400 orientation, distance, 3D location estimates of the object obtained from the neural network and/or other sensors (e.g., LIDAR sensor(s) 464 or RADAR sensor(s) 460), among others.

The SoC(s) 404 may include data store(s) 416 (e.g., memory). The data store(s) 416 may be on-chip memory of the SoC(s) 404, which may store neural networks to be executed on the GPU and/or the DLA. In some examples, the data store(s) 416 may be large enough in capacity to store multiple instances of neural networks for redundancy and safety. The data store(s) 412 may comprise L2 or L3 cache(s) 412. Reference to the data store(s) 416 may include reference to the memory associated with the PVA, DLA, and/or other accelerator(s) 414, as described herein.

The SoC(s) 404 may include one or more processor(s) 410 (e.g., embedded processors). The processor(s) 410 may include a boot and power management processor that may be a dedicated processor and subsystem to handle boot power and management functions and related security enforcement. The boot and power management processor may be a part of the SoC(s) 404 boot sequence and may provide runtime power management services. The boot power and management processor may provide clock and voltage programming, assistance in system low power state transitions, management of SoC(s) 404 thermals and temperature sensors, and/or management of the SoC(s) 404 power states. Each temperature sensor may be implemented as a ring-oscillator whose output frequency is proportional to temperature, and the SoC(s) 404 may use the ring-oscillators to detect temperatures of the CPU(s) 406, GPU(s) 408, and/or accelerator(s) 414. If temperatures are determined to exceed a threshold, the boot and power management processor may enter a temperature fault routine and put the SoC(s) 404 into a lower power state and/or put the vehicle 400 into a chauffeur to safe stop mode (e.g., bring the vehicle 400 to a safe stop).

The processor(s) 410 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 410 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 410 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 410 may further include a real-time camera engine that may include a dedicated processor subsystem for handling real-time camera management.

The processor(s) 410 may further include a high-dynamic range signal processor that may include an image signal processor that is a hardware engine that is part of the camera processing pipeline.

The processor(s) 410 may include a video image compositor that may be a processing block (e.g., implemented on a microprocessor) that implements video post-processing functions needed by a video playback application to produce the final image for the player window. The video image compositor may perform lens distortion correction on wide-view camera(s) 470, surround camera(s) 474, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 408 is not required to continuously render new surfaces. Even when the GPU(s) 408 is powered on and active doing 3D rendering, the video image compositor may be used to offload the GPU(s) 408 to improve performance and responsiveness.

The SoC(s) 404 may further include a mobile industry processor interface (MIPI) camera serial interface for receiving video and input from cameras, a high-speed interface, and/or a video input block that may be used for camera and related pixel input functions. The SoC(s) 404 may further include an input/output controller(s) that may be controlled by software and may be used for receiving I/O signals that are uncommitted to a specific role.

The SoC(s) 404 may further include a broad range of peripheral interfaces to enable communication with peripherals, audio codecs, power management, and/or other devices. The SoC(s) 404 may be used to process data from cameras (e.g., connected over Gigabit Multimedia Serial Link and Ethernet), sensors (e.g., LIDAR sensor(s) 464, RADAR sensor(s) 460, etc. that may be connected over Ethernet), data from bus 402 (e.g., speed of vehicle 400, steering wheel position, etc.), data from GNSS sensor(s) 458 (e.g., connected over Ethernet or CAN bus). The SoC(s) 404 may further include dedicated high-performance mass storage controllers that may include their own DMA engines, and that may be used to free the CPU(s) 406 from routine data management tasks.

The SoC(s) 404 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 404 may be faster, more reliable, and even more energy-efficient and space-efficient than conventional systems. For example, the accelerator(s) 414, when combined with the CPU(s) 406, the GPU(s) 408, and the data store(s) 416, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 420) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 408.

In some examples, a CNN for facial recognition and vehicle owner identification may use data from camera sensors to identify the presence of an authorized driver and/or owner of the vehicle 400. The always on sensor processing engine may be used to unlock the vehicle when the owner approaches the driver door and turn on the lights, and, in security mode, to disable the vehicle when the owner leaves the vehicle. In this way, the SoC(s) 404 provide for security against theft and/or carjacking.

In another example, a CNN for emergency vehicle detection and identification may use data from microphones 496 to detect and identify emergency vehicle sirens. In contrast to conventional systems, that use general classifiers to detect sirens and manually extract features, the SoC(s) 404 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 458. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 462, until the emergency vehicle(s) passes.

The vehicle may include a CPU(s) 418 (e.g., discrete CPU(s), or dCPU(s)), that may be coupled to the SoC(s) 404 via a high-speed interconnect (e.g., PCIe). The CPU(s) 418 may include an X86 processor, for example. The CPU(s) 418 may be used to perform any of a variety of functions, including arbitrating potentially inconsistent results between ADAS sensors and the SoC(s) 404, and/or monitoring the status and health of the controller(s) 436 and/or infotainment SoC 430, for example.

The vehicle 400 may include a GPU(s) 420 (e.g., discrete GPU(s), or dGPU(s)), that may be coupled to the SoC(s) 404 via a high-speed interconnect (e.g., NVIDIA's NVLINK). The GPU(s) 420 may provide additional artificial intelligence functionality, such as by executing redundant and/or different neural networks, and may be used to train and/or update neural networks based on input (e.g., sensor data) from sensors of the vehicle 400.

The vehicle 400 may further include the network interface 424 which may include one or more wireless antennas 426 (e.g., one or more wireless antennas for different communication protocols, such as a cellular antenna, a Bluetooth antenna, etc.). The network interface 424 may be used to enable wireless connectivity over the Internet with the cloud (e.g., with the server(s) 478 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 400 information about vehicles in proximity to the vehicle 400 (e.g., vehicles in front of, on the side of, and/or behind the vehicle 400). This functionality may be part of a cooperative adaptive cruise control functionality of the vehicle 400.

The network interface 424 may include a SoC that provides modulation and demodulation functionality and enables the controller(s) 436 to communicate over wireless networks. The network interface 424 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA4000, Bluetooth, Bluetooth LE, Wi-Fi, Z-Wave, ZigBee, LoRaWAN, and/or other wireless protocols.

The vehicle 400 may further include data store(s) 428 which may include off-chip (e.g., off the SoC(s) 404) storage. The data store(s) 428 may include one or more storage elements including RAM, SRAM, DRAM, VRAM, Flash, hard disks, and/or other components and/or devices that may store at least one bit of data.

The vehicle 400 may further include GNSS sensor(s) 458. The GNSS sensor(s) 458 (e.g., GPS, assisted GPS sensors, differential GPS (DGPS) sensors, etc.), to assist in mapping, perception, occupancy grid generation, and/or path planning functions. Any number of GNSS sensor(s) 458 may be used, including, for example and without limitation, a GPS using a USB connector with an Ethernet to Serial (RS-432) bridge.

The vehicle 400 may further include RADAR sensor(s) 460. The RADAR sensor(s) 460 may be used by the vehicle 400 for long-range vehicle detection, even in darkness and/or severe weather conditions. RADAR functional safety levels may be ASIL B. The RADAR sensor(s) 460 may use the CAN and/or the bus 402 (e.g., to transmit data generated by the RADAR sensor(s) 460) for control and to access object tracking data, with access to Ethernet to access raw data in some examples. A wide variety of RADAR sensor types may be used. For example, and without limitation, the RADAR sensor(s) 460 may be suitable for front, rear, and side RADAR use. In some example, Pulse Doppler RADAR sensor(s) are used.

The RADAR sensor(s) 460 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 450 m range. The RADAR sensor(s) 460 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 400 surroundings at higher speeds with minimal interference from traffic in adjacent lanes. The other two antennae may expand the field of view, making it possible to quickly detect vehicles entering or leaving the vehicle's 400 lane.

Mid-range RADAR systems may include, as an example, a range of up to 460m (front) or 80 m (rear), and a field of view of up to 42 degrees (front) or 450 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 400 may further include ultrasonic sensor(s) 462. The ultrasonic sensor(s) 462, which may be positioned at the front, back, and/or the sides of the vehicle 400, may be used for park assist and/or to create and update an occupancy grid. A wide variety of ultrasonic sensor(s) 462 may be used, and different ultrasonic sensor(s) 462 may be used for different ranges of detection (e.g., 2.5 m, 4 m). The ultrasonic sensor(s) 462 may operate at functional safety levels of ASIL B.

The vehicle 400 may include LIDAR sensor(s) 464. The LIDAR sensor(s) 464 may be used for object and pedestrian detection, emergency braking, collision avoidance, and/or other functions. The LIDAR sensor(s) 464 may be functional safety level ASIL B. In some examples, the vehicle 400 may include multiple LIDAR sensors 464 (e.g., two, four, six, etc.) that may use Ethernet (e.g., to provide data to a Gigabit Ethernet switch).

In some examples, the LIDAR sensor(s) 464 may be capable of providing a list of objects and their distances for a 360-degree field of view. Commercially available LIDAR sensor(s) 464 may have an advertised range of approximately 400 m, with an accuracy of 2 cm-3 cm, and with support for a 400 Mbps Ethernet connection, for example. In some examples, one or more non-protruding LIDAR sensors 464 may be used. In such examples, the LIDAR sensor(s) 464 may be implemented as a small device that may be embedded into the front, rear, sides, and/or corners of the vehicle 400. The LIDAR sensor(s) 464, in such examples, may provide up to a 120-degree horizontal and 35-degree vertical field-of-view, with a 400 m range even for low-reflectivity objects. Front-mounted LIDAR sensor(s) 464 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 400 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 400. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 464 may be less susceptible to motion blur, vibration, and/or shock.

The vehicle may further include IMU sensor(s) 466. The IMU sensor(s) 466 may be located at a center of the rear axle of the vehicle 400, in some examples. The IMU sensor(s) 466 may include, for example and without limitation, an accelerometer(s), a magnetometer(s), a gyroscope(s), a magnetic compass(es), and/or other sensor types. In some examples, such as in six-axis applications, the IMU sensor(s) 466 may include accelerometers and gyroscopes, while in nine-axis applications, the IMU sensor(s) 466 may include accelerometers, gyroscopes, and magnetometers.

In some embodiments, the IMU sensor(s) 466 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 466 may enable the vehicle 400 to estimate heading without requiring input from a magnetic sensor by directly observing and correlating the changes in velocity from GPS to the IMU sensor(s) 466. In some examples, the IMU sensor(s) 466 and the GNSS sensor(s) 458 may be combined in a single integrated unit.

The vehicle may include microphone(s) 496 placed in and/or around the vehicle 400. The microphone(s) 496 may be used for emergency vehicle detection and identification, among other things.

The vehicle may further include any number of camera types, including stereo camera(s) 468, wide-view camera(s) 470, infrared camera(s) 472, surround camera(s) 474, long-range and/or mid-range camera(s) 498, and/or other camera types. The cameras may be used to capture image data around an entire periphery of the vehicle 400. The types of cameras used depends on the embodiments and requirements for the vehicle 400, and any combination of camera types may be used to provide the necessary coverage around the vehicle 400. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 4A and FIG. 4B.

The vehicle 400 may further include vibration sensor(s) 442. The vibration sensor(s) 442 may measure vibrations of components of the vehicle, such as the axle(s). For example, changes in vibrations may indicate a change in road surfaces. In another example, when two or more vibration sensors 442 are used, the differences between the vibrations may be used to determine friction or slippage of the road surface (e.g., when the difference in vibration is between a power-driven axle and a freely rotating axle).

The vehicle 400 may include an ADAS system 438. The ADAS system 438 may include a SoC, in some examples. The ADAS system 438 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 460, LIDAR sensor(s) 464, and/or a camera(s). The ACC systems may include longitudinal ACC and/or lateral ACC. Longitudinal ACC monitors and controls the distance to the vehicle immediately ahead of the vehicle 400 and automatically adjust the vehicle speed to maintain a safe distance from vehicles ahead. Lateral ACC performs distance keeping, and advises the vehicle 400 to change lanes when necessary. Lateral ACC is related to other ADAS applications such as LCA and CWS.

CACC uses information from other vehicles that may be received via the network interface 424 and/or the wireless antenna(s) 426 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 400), while the 12V communication concept provides information about traffic further ahead. CACC systems may include either or both 12V and V2V information sources. Given the information of the vehicles ahead of the vehicle 400, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 460, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 460, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 400 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 400 if the vehicle 400 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 400 is backing up. Some RCTW systems include AEB to ensure that the vehicle brakes are applied to avoid a crash. RCTW systems may use one or more rear-facing RADAR sensor(s) 460, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 400, the vehicle 400 itself must, in the case of conflicting results, decide whether to heed the result from a primary computer or a secondary computer (e.g., a first controller 436 or a second controller 436). For example, in some embodiments, the ADAS system 438 may be a backup and/or secondary computer for providing perception information to a backup computer rationality module. The backup computer rationality monitor may run a redundant diverse software on hardware components to detect faults in perception and dynamic driving tasks. Outputs from the ADAS system 438 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 404.

In other examples, ADAS system 438 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 438 may be fed into the primary computer's perception block and/or the primary computer's dynamic driving task block. For example, if the ADAS system 438 indicates a forward crash warning due to an object immediately ahead, the perception block may use this information when identifying objects. In other examples, the secondary computer may have its own neural network which is trained and thus reduces the risk of false positives, as described herein.

The vehicle 400 may further include the infotainment SoC 430 (e.g., an in-vehicle infotainment system (IVI)). Although illustrated and described as a SoC, the infotainment system may not be a SoC, and may include two or more discrete components. The infotainment SoC 430 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 400. For example, the infotainment SoC 430 may radios, disk players, navigation systems, video players, USB and Bluetooth connectivity, carputers, in-car entertainment, Wi-Fi, steering wheel audio controls, hands free voice control, a heads-up display (HUD), an HMI display 434, a telematics device, a control panel (e.g., for controlling and/or interacting with various components, features, and/or systems), and/or other components. The infotainment SoC 430 may further be used to provide information (e.g., visual and/or audible) to a user(s) of the vehicle, such as information from the ADAS system 438, autonomous driving information such as planned vehicle maneuvers, trajectories, surrounding environment information (e.g., intersection information, vehicle information, road information, etc.), and/or other information.

The infotainment SoC 430 may include GPU functionality. The infotainment SoC 430 may communicate over the bus 402 (e.g., CAN bus, Ethernet, etc.) with other devices, systems, and/or components of the vehicle 400. In some examples, the infotainment SoC 430 may be coupled to a supervisory MCU such that the GPU of the infotainment system may perform some self-driving functions in the event that the primary controller(s) 436 (e.g., the primary and/or backup computers of the vehicle 400) fail. In such an example, the infotainment SoC 430 may put the vehicle 400 into a chauffeur to safe stop mode, as described herein.

The vehicle 400 may further include an instrument cluster 432 (e.g., a digital dash, an electronic instrument cluster, a digital instrument panel, etc.). The instrument cluster 432 may include a controller and/or supercomputer (e.g., a discrete controller or supercomputer). The instrument cluster 432 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 430 and the instrument cluster 432. In other words, the instrument cluster 432 may be included as part of the infotainment SoC 430, or vice versa.

FIG. 4D is a system diagram for communication between cloud-based server(s) and the exemplar autonomous vehicle 400 of FIG. 4A, according to various embodiments. The system 476 may include server(s) 478, network(s) 490, and vehicles, including the vehicle 400. The server(s) 478 may include a plurality of GPUs 484(A)-484(H) (collectively referred to herein as GPUs 484), PCIe switches 482(A)-482(H) (collectively referred to herein as PCIe switches 482), and/or CPUs 480(A)-480(B) (collectively referred to herein as CPUs 480). The GPUs 484, the CPUs 480, and the PCIe switches may be interconnected with high-speed interconnects such as, for example and without limitation, NVLink interfaces 488 developed by NVIDIA and/or PCIe connections 486. In some examples, the GPUs 484 are connected via NVLink and/or NVSwitch SoC and the GPUs 484 and the PCIe switches 482 are connected via PCIe interconnects. Although eight GPUs 484, two CPUs 480, and two PCIe switches are illustrated, this is not intended to be limiting. Depending on the embodiment, each of the server(s) 478 may include any number of GPUs 484, CPUs 480, and/or PCIe switches. For example, the server(s) 478 may each include eight, sixteen, thirty-two, and/or more GPUs 484.

The server(s) 478 may receive, over the network(s) 490 and from the vehicles, image data representative of images showing unexpected or changed road conditions, such as recently commenced road-work. The server(s) 478 may transmit, over the network(s) 490 and to the vehicles, neural networks 492, updated neural networks 492, and/or map information 494, including information regarding traffic and road conditions. The updates to the map information 494 may include updates for the HD map 422, such as information regarding construction sites, potholes, detours, flooding, and/or other obstructions. In some examples, the neural networks 492, the updated neural networks 492, and/or the map information 494 may have resulted from new training and/or experiences represented in data received from any number of vehicles in the environment, and/or based on training performed at a datacenter (e.g., using the server(s) 478 and/or other servers).

The server(s) 478 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 490, and/or the machine learning models may be used by the server(s) 478 to remotely monitor the vehicles.

In some examples, the server(s) 478 may receive data from the vehicles and apply the data to up-to-date real-time neural networks for real-time intelligent inferencing. The server(s) 478 may include deep-learning supercomputers and/or dedicated AI computers powered by GPU(s) 484, such as a DGX and DGX Station machines developed by NVIDIA. However, in some examples, the server(s) 478 may include deep learning infrastructure that use only CPU-powered datacenters.

The deep-learning infrastructure of the server(s) 478 may be capable of fast, real-time inferencing, and may use that capability to evaluate and verify the health of the processors, software, and/or associated hardware in vehicle 400. For example, the deep-learning infrastructure may receive periodic updates from the vehicle 400, such as a sequence of images and/or objects that the vehicle 400 has located in that sequence of images (e.g., via computer vision and/or other machine learning object classification techniques). The deep-learning infrastructure may run its own neural network to identify the objects and compare them with the objects identified by the vehicle 400 and, if the results do not match and the infrastructure concludes that the AI in the vehicle 400 is malfunctioning, the server(s) 478 may transmit a signal to the vehicle 400 instructing a fail-safe computer of the vehicle 400 to assume control, notify the passengers, and complete a safe parking maneuver.

For inferencing, the server(s) 478 may include the GPU(s) 484 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Controlling Autonomous Vehicles Using Vision-Language Models

As discussed previously, embodiments of the present disclosure provide techniques for controlling an autonomous vehicle (AV) using a vision-language model (VLM) trained to interpret three-dimensional (3D) data. The VLM includes a projector that can be implemented via alternative embodiments. Training of the VLM is performed using training data that is generated via sequential portions of a data generation pipeline. The operation of the data generation pipeline is described below in conjunction with FIGS. 5A-7. The VLM and various projector implementations are described in greater detail below in conjunction with FIGS. 8-10.

### Data Generation Pipeline

FIG. 5A is a more detailed illustration of a first portion of the data generation pipeline of FIG. 1, according to various embodiments. As shown, a portion 150A of the data generation pipeline 150 of FIG. 1 includes an image encoder 500, a semantic clustering module 504, and a trajectory clustering module 508. In operation, image encoder 500 processes annotated image data 152 to generate semantic features 502. Semantic clustering module 504 processes semantic features 502 to generate key frames 506. Trajectory clustering module 508 processes key frames 506 to generate key frames 510. Key frames 510 are further processed by a subsequent portion of the data generation pipeline 150, as described in greater detail below in conjunction with FIG. 5B.

Annotated image data 152 includes multi-dimensional frames of video data captured by sensory equipment that is mounted to a vehicle and configured to record the frames of video data during operation of the vehicle. For example, the multi-dimensional image data could include frames of video data from six viewing angles. Annotated image data 152 also includes 3D position data associated with the vehicle, such as inertial measurement unit (IMU) data, for example and without limitation. Further, annotated image data 152 includes various types of annotations that describe different features includes in the frames of video data. For example, and without limitation, annotated image data 152 could include bounding boxes that indicate specific objects present in one or more frames of video data along with labels that describe those objects. Annotated image data 152 could further include position and/or trajectory information associated with any given object, including a set of 3D coordinates and/or a 3D motion vector, for example and without limitation. Annotated image data 152 could additionally include metadata related to various objects included in any given frame of video data, including object topologies, for example and without limitation. In some embodiments, annotated image data 152 includes at least a portion of a dataset for autonomous driving that includes multi-sensor data collected from real-world driving scenarios (e.g., the nuScenes dataset).

Image encoder 500 is a machine learning module configured to perform an encoding operation to generate embeddings. In some embodiments, image encoder 500 can be a Contrastive Language-Image Pretraining (CLIP) image encoder configured to generate CLIP embeddings. Image encoder 500 is configured to capture diverse perceptual elements including landmarks, traffic lights, and lane markings, among others. Image encoder 500 outputs embeddings derived from annotated image data 152 within semantic features 502. Semantic features 502 include text-based labels for specific elements identified within annotated image data 152.

Semantic clustering module 504 applies a clustering algorithm to determine semantically similar clusters within annotated image data 152. In some embodiments, semantic clustering module 504 may apply a K-means algorithm to determine cluster centers, and may then select a subset of those cluster centers, e.g. 20% of cluster centers. In this manner, semantic clustering module 504 captures semantically representative data from annotated image data 152 that reflects a diverse range of static and dynamic traffic elements. Semantic clustering module 504 outputs key frames 506 to include a subset of annotated image data 152.

Trajectory clustering module 508 then applies a clustering algorithm to determine clusters within key frames 506 having similar vehicle trajectories. In some embodiments, trajectory clustering module 508 can apply a K-means algorithm to determine cluster centers, and can then select a subset of those cluster centers, e.g. 200 cluster centers. Trajectory clustering module 508 thus captures a subset of key frames 506 that represent different vehicle dynamics, reflecting driving behaviors such as stopping, moving forward, turning left, turning right, U-turns, accelerating, decelerating, and maintaining constant speed, among others. Trajectory clustering outputs key frames 510 to include a subset of key frames 506.

The portion 150A of the data generation pipeline 150 thus generates key frames 510 by filtering annotated image data 152 in order to reduce redundancy so that key frames 510 include both a diverse range of traffic and other environmental elements, as well as a diverse set of driving operations and other driving situations. A subsequent portion of the data generation pipeline 150 then processes key frames 150, as described below in conjunction with FIG. 5B.

FIG. 5B is a more detailed illustration of a second portion of the data generation pipeline of FIG. 1, according to various embodiments. As shown, a portion 150B of the data generation pipeline of FIG. 1 includes a counterfactual checklist module 512, a prompt design 520, and one or more LLMs 550. Although described herein primarily with respect to LLMs as a reference example, any technically feasible language models can be used in some embodiments. Prompt design 520 includes a caption generator 522 and a trajectory analyzer 524, which generate prompts 526 using rules (e.g., templates) and/or by prompting LLM(s) 550 to generate at least a portion of prompts 526. Conversation generator 530 includes a scene description module 532, an object attention module 534, a counterfactual reasoning module 536, a decision making & planning module 538, and a general conversations module 539 that generate conversations 540 using rules (e.g., templates) and/or by prompting LLM(s) 550 to generate at least a portion of conversations 540. Once generated, the prompts 526 can be included in context that is input into an LLM, and the conversations 540 can include pairs of natural language instructions (e.g., questions) and responses (e.g., answers to the questions) that are the inputs (along with corresponding image data and prompts 526) and expected outputs, respectively, of a VLM being trained. The VLM can be trained with such training data in any technically feasible manner in some embodiments, such as using backpropagation with gradient descent, or a variation thereof, to minimize a next-token prediction loss. In some embodiments, the VLM can be trained to learn the tasks of (1) scene description based on training data that is generated by scene description module 532 and includes descriptions of scenes surrounding a vehicle, (2) 3D grounding of objects (e.g., outputting 3D information given a 2D bounding box, outputting nearby objects given a 3D coordinate, outputting the types of objects and bounding boxes of those objects given a question about the objects, etc.) based on training data generated by object attention module 534 that includes 3D information such as the coordinates of corners of object bounding boxes, (3) answering counterfactual questions based on training data generated by counterfactual reasoning module 536 that includes counterfactual questions and answers, (4) planning vehicle trajectories based on training data that is generated by decision making & planning module 538 and includes human driving trajectories, and (5) general question answering (e.g., answering what the weather is, what is the time of day, etc.) based on training data that is generated by the general conversations module 539.

In operation, counterfactual checklist module 512 initially analyzes key frames 510 and then converts simulated driving trajectories into high-level decision making information, including object and lane assignment, lane changing behavior, and so forth, for example and without limitation. Counterfactual checklist 512 then determines whether the driving behavior set forth in any given subset of key frames 510 is safe and complies with traffic regulations. In some embodiments, counterfactual checklist can implement an LLM 550, such as, e.g., Generative Pre-trained Transformer (GPT) 4, without limitation. Counterfactual checklist 152 eliminates subsets of key frames 510 that represent driving behaviors deemed unsafe or non-compliant.

Prompt design module 520 analyzes key frames 510 via caption generator 522 and trajectory analyzer 524 to generate prompts 526. Caption generator 522 implements an LLM 550 to generate scene descriptions based on the multidimensional image data included in key frames 152. In some embodiments, caption generator 522 can generate captions for three front camera views stitched together and three rear camera views stitched together. Caption generator 522 instructs the LLM 550 to indicate the weather, time of day, scene type, and other image contents, as well as the general direction of each view, and to avoid discussing the contents of each view independently and to instead describe the various images from the perspective of the vehicle.

Trajectory analyzer 524 also implements an LLM 550 to analyze simulated trajectory descriptions included in key frames 510 to generate expert decision descriptions and expert trajectory descriptions. Expert decision descriptions include high-level logical reasoning that describes driving operations being performed. Expert trajectory descriptions include 3D geometry that describes the physical dynamics of the vehicle, along with topologies of objects proximate to the vehicle and corresponding 3D geometry that represents those objects. Trajectory analyzer 524 further indicates specific objects proximate to the vehicle that require attention. In some embodiments, trajectory analyzer 524 can generate a 3D position encoding based on the 3D position of the vehicle. In the fashion described, caption generator 522 and trajectory analyzer 524 collectively generate prompts 526 that include the various contextual information and then provide prompts 526 to conversation generator 530 for further processing.

Conversation generator 530 implements several different types of modules to generate conversational question and answer (Q&A) dialogues included in conversations 540. Any of these modules may implement one or more LLMs 150 during operation. Scene description 532 generates Q&A dialogues that describe elements within the multidimensional image data within key frames 510. In some embodiments, scene description 532 can simply copy the scene descriptions that are generated via caption generator 522 and included in prompts 526.

Object attention module 534 generates Q&A dialogues based on the simulated and expert trajectory descriptions included in prompts 526 to identify objects that may need specific attention, including potentially threatening traffic elements. In some embodiments, scene description 532 can generate Q&A dialogues that include, among other things, map information such as traffic lanes and the topology of how those traffic lanes are connected. In such cases, the map information can be specified in a folder-like structure. For example, each lane could be a folder with sub-folders indicating pedestrians, objects, etc. in the lane. In some embodiments, object attention module 534 can generate Q&A dialogues relating to general traffic rules. For example, the Q&A dialogues could indicate, based on the traffic rules in a given driving environment, what objects the VLM should pay attention to. As a specific example, when image data indicates that a vehicle is at an intersection, the objects to pay attention to could include a stop sign or traffic light. In some embodiments, object attention module 534 can also enable 3D grounding by generating Q&A dialogues that includes 3D object information, such as the coordinates of corners of bounding boxes of objects.

Counterfactual reasoning module 536 analyzes simulated and expert trajectory descriptions included in prompts 526 to determine compliance with traffic laws and identify potentially dangerous traffic conditions. For example, in some embodiments, counterfactual reasoning module 536 can simulate to check if the trajectories violate traffic rules, such as running a red light, or cause collisions with other objects or the road boundary.

Decision making & planning module 538 analyzes prompts 526 to generate detailed Q&A dialogues that explain logical reasoning and rationale behind specific driving operations. In some embodiments, decision making & planning module 538 can also generate Q&A dialogues that include planned trajectories based on vehicle trajectories from when a human was driving. In such cases, a VLM can be trained via imitation learning to perform planning of vehicle trajectories in a similar manner to the human driving.

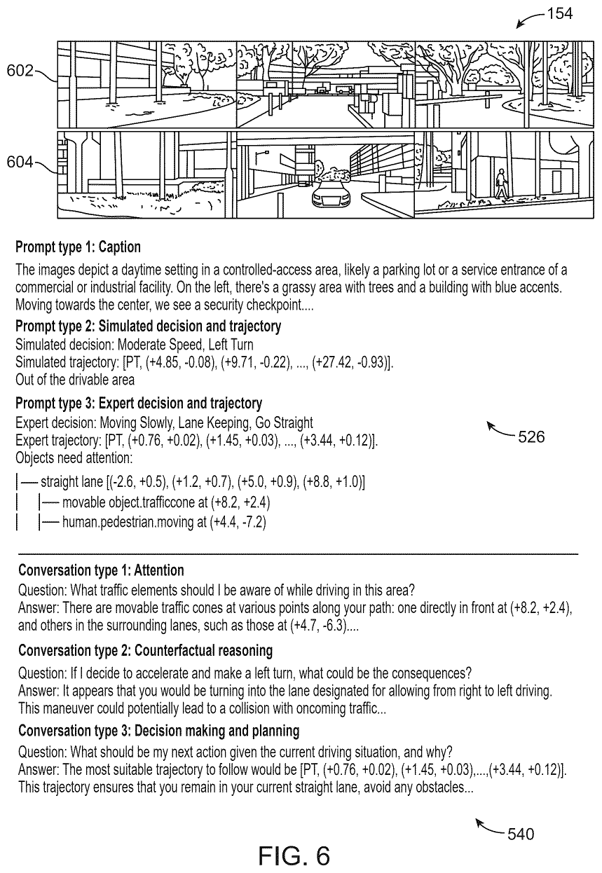

General conversations module 539 prompts LLM(s) 550 to generate multi-turn dialogue based on caption information from prompts 526 and image content, involving object counts, color, relative position, and/or optical character recognition (OCR)-type tasks. In the manner described, the different modules within conversation generator 530 operate to generate Q&A dialogues included in conversations 540. Key frames 510, prompts 526, and conversations 540, in combination with one another, form training data 154 that can be used to train a VLM (e.g., to re-train trained VLM 118 to generate re-trained VLM 146), as described above. An exemplary portion of training data 154 is described in greater detail below in conjunction with FIG. 6.

FIG. 6 is a more detailed illustration of the training data of FIG. 1, according to various embodiments. As shown, training data 154 includes front view images 602 and rear view images 604, prompts 526, and conversations 540. Front view images 602 include several images captured via optical sensors oriented towards the front of a vehicle, while rear view images 604 include several images captured via optical sensors oriented towards the rear of the vehicle. In some embodiments, front view images 602 and rear view images 604 include multiple images stitched together.

Prompts 526 include the several different types of prompts described above in conjunction with FIG. 5B, including captions generated via caption generator 522, and different trajectories generated via trajectory analyzer 524, including expert trajectories of a human driver, objects that need attention, and a folder of the map information that includes a folder for a straight lane, a sub-folder for movable objects in the straight lane, and another sub-folder for pedestrians in the straight lane. Conversations 540 include the several different types of Q&A dialogues described above in conjunction with FIG. 5B, including attention, counterfactual reasoning, and decision making & planning. Persons skilled in the art will understand that the training data 154 shown in FIG. 6 is provided for exemplary purposes only and is not meant to limit the scope of the various embodiments.

FIG. 7 is a flow diagram of method steps for generating training data for training a vision language model (VLM), according to various embodiments. Although the method steps are described in conjunction with the systems of FIGS. 1-6, persons skilled in the art will understand that any system configured to perform the method steps in any order falls within the scope of the present embodiments.

As shown, a method 700 begins at step 702, where image encoder 500 extracts semantic features 502 from annotated image data 152 representing the environment where driving occurs. Annotated image data 152 includes multi-dimensional frames of video data captured by sensory equipment that is mounted to a vehicle and configured to record the frames of video data during operation of the vehicle. Image encoder 500 is a machine learning module configured to perform an encoding operation to generate embeddings. In some embodiments, image encoder 500 can be a CLIP image encoder configured to generate CLIP embeddings.

At step 704, semantic clustering module 504 performs a first clustering operation with semantic features 502 to determine key frames 506 included in annotated image data 152 with diverse semantic features. In some embodiments, semantic clustering module 504 can apply a K-means algorithm to determine cluster centers, and may then select a subset of those cluster centers in order to capture semantically representative data from annotated image data 152 reflecting a diverse range of static and dynamic traffic elements.

At step 706, trajectory clustering module 508 applies a second clustering algorithm to determine key frames 510 with diverse trajectories. In some embodiments, trajectory clustering module 508 can apply a K-means algorithm to determine cluster centers, and may then select a subset of those cluster centers, in order to capture a subset of key frames 506 that represent different vehicle dynamics. These vehicle dynamics may reflect driving behaviors such as stopping, moving forward, turning left, turning right, U-turns, accelerating, decelerating, and maintaining constant speed, among others. Key frames 510 thus includes both a diverse range of traffic and other environmental elements, as well as a diverse set of driving operations and other driving situations.

At step 708, counterfactual checklist 512 determines whether the driving behavior set forth in any given subset of key frames 510 is safe and complies with traffic regulations. In some embodiments, counterfactual checklist can implement an LLM 550, such as, e.g., GPT-4, without limitation. Counterfactual checklist 152 eliminates subsets of key frames 510 that represent driving behaviors deemed unsafe or non-compliant.

At step 710, prompt design 520 analyzes key frames 510 via caption generator 522 and trajectory analyzer 524 to generate prompts 526. The operations performed by caption generator 522 and trajectory analyzer 524 are described in greater detail above in conjunction with FIG. 5B.

At step 712, conversation generator 530 generates conversations 540 based on key frames 510 and prompts 526. Conversation generator 530 implements several different types of modules to generate conversational question and answer Q&A dialogues included in conversations 540, such as scene description module 532, object attention module 534, counterfactual reasoning module 536, decision making & planning module 538, and general conversations module 539, described above in conjunction with FIG. 5B.

At step 714, data generation pipeline 150 generates training data 154 that includes key frames 510, prompts 526, and conversations 540. An exemplary portion of training data 154 is described above in conjunction with FIG. 6. In various embodiments, training data 154 is curated via human interaction prior to, or during, batch production of larger volumes of training data 154. Via the techniques described above in conjunction with FIGS. 5A-7, data generation pipeline 150 generates rich and complex training data that can subsequently be used for training and/or fine-tuning VLMs, as described above in conjunction with FIG. 5B. FIGS. 8-10 set forth a VLM architecture that can be trained using the training data 154.

### VLM Architecture

FIG. 8 is a more detailed illustration of the re-trained VLM of FIG. 1, according to various embodiments. As shown, re-trained VLM 146 includes a projector 800 and one or more LLMs 810. Projector 800 is configured to process 3D position encoding (PE) 802 in conjunction with multi-view image features 804 to generate aligned image features 806. LLMs 810 then process aligned image features 806 to generate a driving plan 812 for operating a vehicle. The driving plan 812 can include, for example and without limitation, a high-level description of driving operations and corresponding rationale to support decision making and/or lower-level data such as 3D trajectories.

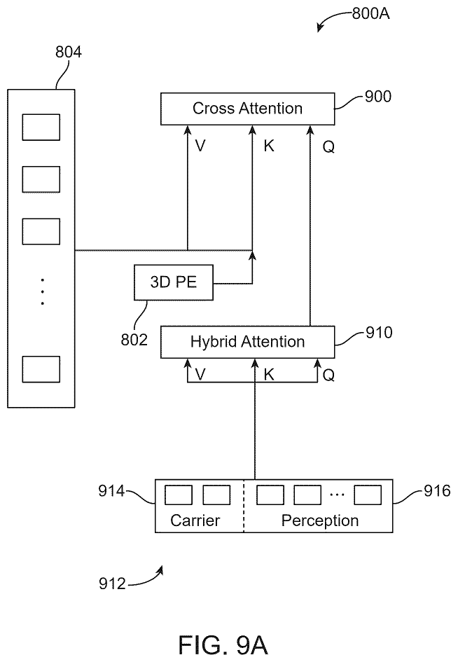

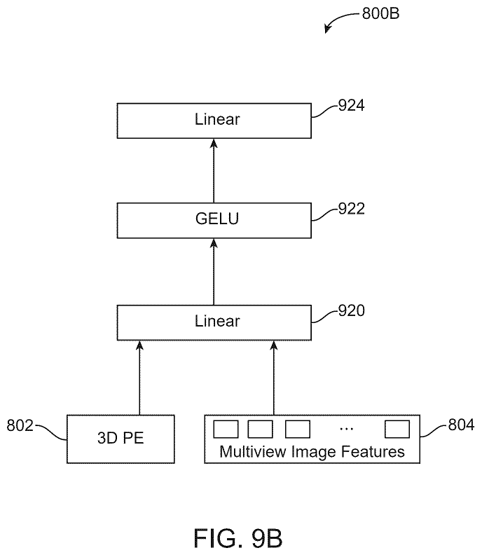

Projector 800 includes Omni-Q 800A and Omni-L 800B. Omni-Q 800A and Omni-L 800B represent alternative implementations of projector 800 and are described in greater detail below in conjunction with FIGS. 9A and 9B, respectively, according to various embodiments. Projector 800 is generally configured to process 3D PE 802 in combination with multi-view image features 804 in order to align visual features with language. Multi-view image features 804 can be generated by encoding multidimensional image data via a visual encoder, according to some embodiments. Projector 800 can be trained, as part of VLM 146, by re-training application 116 using training data 154 described above in conjunction with FIGS. 5A-7. In some embodiments, re-training application 116 can train a VLM via a multi-step process that involves pretraining on 2D image tasks followed by fine tuning on 3D driving tasks.

FIG. 9A is a more detailed illustration of the Omni-Q projector of FIG. 8, according to various embodiments. As shown, Omni-Q 800A includes cross attention 900 and hybrid attention 910. Hybrid attention 910 processes queries 912 that include carrier queries 914 and perception queries 916. Carrier queries 914 and/or perception queries 916 include embeddings of learnable features. Perception queries 916 are used to predict categories and coordinates of foreground elements. Carrier queries 914 are used for text generation. Hybrid attention 910 processes carrier queries 914 and perception queries 916 in order to exchange information between such queries, and an output of hybrid attention 910 is input into cross attention 900.

Cross attention 900 receives multi-view image features 804(value) and a combination of 3D PE 802 with multi-view image features 804(key) for processing in conjunction with the output of hybrid attention 910(query). In cross attention 900, carrier and perception queries output by hybrid attention 910 collect information from multi-view images. In particular, the carrier and perception queries perform cross attention with image features, but the carrier and perception queries have different destinations. The perception queries are used to output perception results including the categories and/or coordinates of foreground elements, such as bounding boxes or lane center lines. The carrier queries are transformed into visual tokens for input into LLM 810. As a general matter, in Omni-Q 800A, carrier queries provide visual language alignment, allowing geometric priors set forth in PE 802 to be used as well as query-based representations acquired via 3D perception tasks.

More formally, Omni-L/Q use a shared visual encoder to extract multi-view image features Fₘ ∈ R^{N×C×H×W}. The extracted features are combined with the positional encoding Pₘ and then fed into a projector. The visual features are aligned with the text in the projector and then fed into a large language model for text generation tasks. The main difference between Omni-L and Omni-Q lies in the design of the projector, one of which prioritizes vision-language alignment, while the other focuses on 3D perception tasks.

The Transformer decoder in Q-Former and the sparse query-based 3D perception models, represented by StreamPETR, share highly similar architecture designs. To enhance the localization abilities of the VLMs, the design of 3D position encoding Pₘ and the supervision of the query-based perception models are introduced to the training of VLMs. In QFormer, the detection queries and carrier queries are initialized and perform self-attention to exchange their information, which can be summarized by the following formula:

$$\begin{matrix}( Q , K , V ) = ( [ {Q}_{c} , {Q}_{d} ] , [ {Q}_{c} , {Q}_{d} ] , [ {Q}_{c} , {Q}_{d} ] ) \\ {Q}^{′} = Multi - head Attention ( Q , K , V )\end{matrix} , \qquad ( 1 )$$

where [·] is the concatenation operation. For simplicity, the position encoding has been omitted. Then, these queries collect information from multi-view images via:

$$\begin{matrix}( Q , K , V ) = ( [ {Q}_{c} , {Q}_{d} ] , {P}_{m} + {F}_{m} , {F}_{m} ) \\ {Q}^{′} = Multi - head Attention ( Q , K , V )\end{matrix} \qquad ( 2 )$$

Afterward, the perception queries Q_{d} are used to predict the categories and coordinates of the foreground elements. The carrier queries Q_{c} are sent to a MLP to align with the dimension of LLM tokens and further used for text generation.

In Omni-Q, the carrier queries play the role of the visual language alignment. Additionally, this design enables carrier queries to leverage the geometric priors provided by the 3D position encoding, while also allowing the carrier queries to leverage query-based representations acquired through the 3D perception tasks.

FIG. 9B is a more detailed illustration of the Omni-L projector of FIG. 8, according to various embodiments. As shown, Omni-L 800B includes a pipeline of units configured to implement an MLP for aligning the visual-language embedding space, including linear layer 920, gaussian error linear unit (GELU) 922, and linear layer 924. In operation, linear layer 920, GELU 922, and linear layer 924 receive 3D PE 802 in combination with multi-view image features 804 and flattens multi-view image features 804 prior to transmission to LLM 810. To distinguish different viewpoints, 3D position encoding Pₘ is added to each image patch. However, for training stability, the position encoding weights can be initialized to zero. In Omni-L 800B, 3D PE 802 and multi-view image features 804 are processed to generate visual tokens that can be combined with language tokens for processing by LLM 810.

In some embodiments, the training of Omni-L/Q includes two stages: 2D pretraining and 3D finetuning. In the 2D pretraining stage, VLMs are pre-trained on 2D image tasks to initialize the QFormer/MLP projector therein. In the 3D finetuning stage, the VLMs are finetuned on 3D-related driving tasks (e.g., motion planning, counter-factual reasoning, etc.). In both stages, a text generation loss can be used without considering contrasting learning and matching loss.

Referring generally to FIGS. 9A-9B, Omni-Q 800A and Omni-L 800B represent alternative implementations of projector 800 that both operate to align visual and language features while incorporating 3D position information. This approach provides significant advantages over conventional architectures that are limited to operating with 2D information. Accordingly, the driving plan 812 generated via LLMs 810, based on aligned image features 806, can be used to operate the vehicle more safely and with greater compliance to traffic regulations.

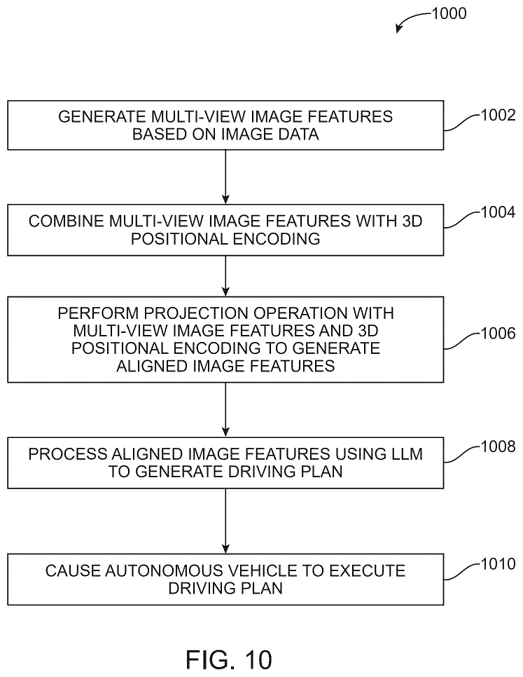

FIG. 10 is a flow diagram of method steps for generating a driving plan for an autonomous vehicle, according to various embodiments. Although the method steps are described in conjunction with the systems of FIGS. 1-9B, persons skilled in the art will understand that any system configured to perform the method steps in any order falls within the scope of the present embodiments.

As shown, a method 1000 begins at step 1002, where re-trained VLM 146 generates multi-view image features 804 based on image data. Multi-view image features 804 include visual feature embeddings and/or tokens derived from sensor data captured by sensors mounted to a vehicle. In some embodiments, the sensor data can include one or more front view images, stitched together, and one or more rear view images, stitched together. Re-trained VLM 146 can generate multi-view image features 804 using a visual encoder, for example and without limitation.

At step 1004, re-trained VLM 146 combines multi-view image features 804 with 3D PE 802. 3D PE 802 includes an encoding of position data captured by sensors mounted to the vehicle. In some embodiments, 3D PE 802 can include a fixed number of 3D locations along a 3D ray, encoded into a multidimensional vector using an MLP. The fixed number of locations could correspond, for example and without limitation, to the current 3D trajectory of the vehicle. Re-trained VLM 146 may combine multi-view image features 804 and 3D PE 802 by appending 3D PE 802 to tokens associated with multi-view image features 804, for example and without limitation.

At step 1006, projector 800 within re-trained VLM 146 performs a projection operation with multi-view image features 804 and 3D PE 802 to generate aligned image features 806. Aligned image features 806 include visual-language aligned features. In some embodiments, projector 800 can be implemented via Omni-Q 800A, described above in conjunction with FIG. 9A, to perform step 1006. In some other embodiments, projector 800 can be implemented via Omni-L 800B, described above in conjunction with FIG. 9B, to perform step 1006.

At step 1008, one or more LLMs 810 process aligned image features 806 in order to generate driving plan 812. LLMs 810 are configured to analyze the aligned visual and language features included in aligned image features 806 and to then generate high-level driving guidance as well as lower-level 3D trajectories for operating the vehicle. LLMs 810 output driving plan 812 for execution by the vehicle. At step 1010, re-trained VLM 146 causes the vehicle to execute driving plan 812.

In sum, embodiments of the present disclosure provide techniques for controlling an autonomous vehicle using a vision-language model trained to interpret 3D data. The VLM includes a projector that is configured to process multi-view image features and a 3D position encoding to generate aligned image features. One or more LLMs are configured to process the aligned image features in order to generate a driving plan for controlling the AV. In some embodiments, one implementation of the projector includes a hybrid attention module that processes carrier and perception queries to exchange information between such queries, and a cross attention module that permits the carrier and perception queries to collect information from multi-view images. The cross attention module processes a value, key, and query that include multi-view image features, a combination of the 3D position encoding and the multi-view image features, and an output of the hybrid attention module, respectively. Perception queries output by the cross attention module are used to predict perception results including the categories and/or coordinates of foreground elements, such as bounding boxes or lane center lines. An LLM processes visual tokens generated by projecting carrier queries output by the cross attention module to generate the driving plan. In some other embodiments, an alternative implementation of the projector includes one or more linear input layers, one or more Gaussian Error Linear Units, and one or more linear output layers, forming an MLP. In this implementation, the MLP processes the multi-view image features and 3D position data to align visual and language embedding spaces and outputs tokens that an LLM then processes to generate the driving plan. In either implementation, the VLM can be trained using annotated image data that is generated via a data generation pipeline.

In various embodiments, the disclosed data generation pipeline includes at least two phases of data generation. In a first phase of data generation, an image encoder encodes annotated image data derived from a dataset for autonomous driving that includes multi-sensor data collected from real-world driving scenarios (e.g., the nuScenes dataset) to extract semantic features. A semantic clustering module performs a clustering operation based on the semantic features to extract a set of key frames that include a diverse collection of different driving situations. A trajectory clustering module then performs another clustering operation to identify a subset of the key frames that include a diverse collection of different driving trajectories. The resultant key frames include images and corresponding annotations that represent both diverse driving situations and diverse trajectories. The annotations include metadata derived from the dataset for autonomous driving, including object labels, bounding boxes, trajectories, hierarchical object topologies, and other language descriptions of features included in the corresponding images. In a second phase of data generation, a counterfactual checklist module validates the set of key frames output by the first phase of data generation. The counterfactual checklist module applies a set of rules to determine whether the driving behavior set forth in the key frames adheres to driving and safety regulations. A prompt designer then evaluates the key frames and generates captions and one or more simulated trajectories and driving decisions for each image. A given caption describes the features of the image in detail. A given trajectory includes a set of points along which the vehicle travels. A given driving decision explains the rationale behind causing the vehicle to follow a corresponding trajectory. The prompt design module generates a set of prompts based on the captions, trajectories, and driving decisions. A conversation generator then generates a set of conversations that include question and answer (Q&A) dialogues related to different aspects of driving. The conversation generator generates Q&A dialogues related to scene descriptions, object attention, counterfactual reasoning, decision making and planning, and other areas where logical reasoning is applied during driving. The annotated image data, in combination with the prompts generated via the prompt designer and the Q&A dialogues generated via the conversation generator, form the training data. The training data can be used to train and/or fine-tune the VLM described above.

At least one technical advantage of the disclosed techniques relative to the prior art is that, with the disclosed techniques, VLMs can be trained to interpret 3D image and position data similar to that commonly captured by sensor arrays on autonomous vehicles. Accordingly, VLMs configured to operate vehicles can assess the environment surrounding the vehicle with greater depth and accuracy, leading to safer driving decisions that better comply with traffic regulations. Another technical advantage of the disclosed techniques is that the disclosed data generation pipeline provides an efficient technique for generating the diverse training data needed to effectively train the projector to perform visual-language alignment using 3D input data. These technical advantages represent one or more technological improvements over prior art approaches.
1. Various embodiments include a computer-implemented method for controlling a vehicle, the method comprising performing a visual-language alignment operation based on a set of multi-view image features and a three-dimensional position encoding to generate a set of aligned image features, causing a language model to generate a driving plan for operating the vehicle based on the set of aligned image features, wherein the driving plan includes a description of a three-dimensional trajectory for the vehicle, and controlling the vehicle to move based on the driving plan.
2. The computer-implemented method of clause 1, further comprising generating the set of multi-view image features by performing an encoding operation based on a set of multi-view images captured during operation of the vehicle.
3. The computer-implemented method of any of clauses 1-2, further comprising generating the three-dimensional position based on three-dimensional position data captured during operation of the vehicle.
4. The computer-implemented method of any of clauses 1-3, wherein performing the visual-language alignment operation comprises performing a cross attention operation between one or more queries and the set of multi-view image features.
5. The computer-implemented method of any of clauses 1-4, wherein the visual-language alignment operation is performed by performing a hybrid attention operation based on one or more first carrier queries and one or more first perception queries to generate one or more second carrier queries and one or more second perception queries, and performing a cross attention operation based on the one or more second carrier queries, the one or more second perception queries, the three-dimensional position encoding, and the set of multi-view image features, wherein at least one output of the cross attention operation is projected into one or more tokens used by the language model to generate the driving plan.
6. The computer-implemented method of any of clauses 1-5, wherein performing the visual-language alignment operation comprises flattening the multi-view image features via a multi-layer perceptron.
7. The computer-implemented method of any of clauses 1-6, wherein performing the visual-language alignment operation and causing the language model to generate the driving plan are performed by a vision language model that is trained to interpret three-dimensional image data.
8. The computer-implemented method of any of clauses 1-7, further comprising training the vision language model based on annotated image data that includes one or more three-dimensional trajectories.
9. The computer-implemented method of any of clauses 1-8, further comprising training the vision language model by performing a pre-training operation using two-dimensional image data, and performing a finetuning operation using three-dimensional image data.
10. The computer-implemented method of any of clauses 1-9, further comprising modifying, via a multi-layer perceptron, at least one dimension associated with the set of aligned image features based on one or more dimensions associated with the language model.
11. Various embodiments include one or more non-transitory computer-readable media including instructions that, when executed by one or more processors, cause the one or more processors to control a vehicle by performing the steps of performing a visual-language alignment operation based on a set of multi-view image features and a three-dimensional position encoding to generate a set of aligned image features, causing a language model to generate a driving plan for operating the vehicle based on the set of aligned image features, wherein the driving plan includes a description of a three-dimensional trajectory for the vehicle, and controlling the vehicle to move based on the driving plan.
12. The one or more non-transitory computer-readable media of clause 11, further comprising generating the set of multi-view image features by performing an encoding operation based on a set of multi-view images captured during operation of the vehicle.
13. The one or more non-transitory computer-readable media of any of clauses 11-12, further comprising generating the three-dimensional position encoding based on three-dimensional position data captured during operation of the vehicle.
14. The one or more non-transitory computer-readable media of any of clauses 11-13, wherein performing the visual-language alignment operation comprises performing a cross attention operation between one or more queries and the set of multi-view image features.
15. The one or more non-transitory computer-readable media of any of clauses 11-14, wherein the visual-language alignment operation is performed by performing a hybrid attention operation based on one or more first carrier queries and one or more first perception queries to generate one or more second carrier queries and one or more second perception queries, and performing a cross attention operation based on the one or more second carrier queries, the one or more second perception queries, the three-dimensional position encoding, and the set of multi-view image features, wherein at least one output of the cross attention operation is projected into one or more tokens used by the language model to generate the driving plan.
16. The one or more non-transitory computer-readable media of any of clauses 11-15, wherein performing the visual-language alignment operation and causing the language model to generate the driving plan are performed by a vision language model that is trained to interpret three-dimensional image data.
17. The one or more non-transitory computer-readable media of any of clauses 11-16, further comprising training the vision language model based on annotated image data that includes one or more three-dimensional trajectories.
18. The one or more non-transitory computer-readable media of any of clauses 11-17, further comprising generating the set of multi-view image features by performing an encoding operation based on a set of multi-view images captured via one or more sensors coupled to the vehicle.
19. The one or more non-transitory computer-readable media of any of clauses 11-18, further comprising generating the three-dimensional position encoding by processing, via a multilayer perceptron, three-dimensional position data corresponding to a trajectory associated with the vehicle.
20. Various embodiments include a system comprising one or more memories storing instructions, and one or more processors coupled to the one or more memories that, when executing the instructions, perform the steps of performing a visual-language alignment operation based on a set of multi-view image features and a three-dimensional position encoding to generate a set of aligned image features, causing a language model to generate a driving plan for operating the vehicle based on the set of aligned image features, wherein the driving plan includes a description of a three-dimensional trajectory for the vehicle, and controlling the vehicle to move based on the driving plan.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a vehicle, the method comprising:
performing a visual-language alignment operation based on a set of multi-view image features and a three-dimensional position encoding to generate a set of aligned image features;
causing a language model to generate a driving plan for operating the vehicle based on the set of aligned image features, wherein the driving plan includes a description of a three-dimensional trajectory for the vehicle; and
controlling the vehicle to move based on the driving plan.

2. The computer-implemented method of claim 1, further comprising generating the set of multi-view image features by performing an encoding operation based on a set of multi-view images captured during operation of the vehicle.

3. The computer-implemented method of claim 1, further comprising generating the three-dimensional position based on three-dimensional position data captured during operation of the vehicle.

4. The computer-implemented method of claim 1, wherein performing the visual-language alignment operation comprises performing a cross attention operation between one or more queries and the set of multi-view image features.

5. The computer-implemented method of claim 1, wherein the visual-language alignment operation is performed by:
performing a hybrid attention operation based on one or more first carrier queries and one or more first perception queries to generate one or more second carrier queries and one or more second perception queries; and
performing a cross attention operation based on the one or more second carrier queries, the one or more second perception queries, the three-dimensional position encoding, and the set of multi-view image features, wherein at least one output of the cross attention operation is projected into one or more tokens used by the language model to generate the driving plan.

6. The computer-implemented method of claim 1, wherein performing the visual-language alignment operation comprises flattening the multi-view image features via a multi-layer perceptron.

7. The computer-implemented method of claim 1, wherein performing the visual-language alignment operation and causing the language model to generate the driving plan are performed by a vision language model that is trained to interpret three-dimensional image data.

8. The computer-implemented method of claim 7, further comprising training the vision language model based on annotated image data that includes one or more three-dimensional trajectories.

9. The computer-implemented method of claim 7, further comprising training the vision language model by:
performing a pre-training operation using two-dimensional image data; and
performing a finetuning operation using three-dimensional image data.

10. The computer-implemented method of claim 1, further comprising modifying, via a multi-layer perceptron, at least one dimension associated with the set of aligned image features based on one or more dimensions associated with the language model.

11. One or more non-transitory computer-readable media including instructions that, when executed by one or more processors, cause the one or more processors to control a vehicle by performing the steps of:
performing a visual-language alignment operation based on a set of multi-view image features and a three-dimensional position encoding to generate a set of aligned image features;
causing a language model to generate a driving plan for operating the vehicle based on the set of aligned image features, wherein the driving plan includes a description of a three-dimensional trajectory for the vehicle; and
controlling the vehicle to move based on the driving plan.

12. The one or more non-transitory computer-readable media of claim 11, further comprising generating the set of multi-view image features by performing an encoding operation based on a set of multi-view images captured during operation of the vehicle.

13. The one or more non-transitory computer-readable media of claim 11, further comprising generating the three-dimensional position encoding based on three-dimensional position data captured during operation of the vehicle.

14. The one or more non-transitory computer-readable media of claim 11, wherein performing the visual-language alignment operation comprises performing a cross attention operation between one or more queries and the set of multi-view image features.

15. The one or more non-transitory computer-readable media of claim 11, wherein the visual-language alignment operation is performed by:
performing a hybrid attention operation based on one or more first carrier queries and one or more first perception queries to generate one or more second carrier queries and one or more second perception queries; and
performing a cross attention operation based on the one or more second carrier queries, the one or more second perception queries, the three-dimensional position encoding, and the set of multi-view image features, wherein at least one output of the cross attention operation is projected into one or more tokens used by the language model to generate the driving plan.

16. The one or more non-transitory computer-readable media of claim 11, wherein performing the visual-language alignment operation and causing the language model to generate the driving plan are performed by a vision language model that is trained to interpret three-dimensional image data.

17. The one or more non-transitory computer-readable media of claim 16, further comprising training the vision language model based on annotated image data that includes one or more three-dimensional trajectories.

18. The one or more non-transitory computer-readable media of claim 11, further comprising generating the set of multi-view image features by performing an encoding operation based on a set of multi-view images captured via one or more sensors coupled to the vehicle.

19. The one or more non-transitory computer-readable media of claim 11, further comprising generating the three-dimensional position encoding by processing, via a multilayer perceptron, three-dimensional position data corresponding to a trajectory associated with the vehicle.

20. A system comprising:
one or more memories storing instructions; and
one or more processors coupled to the one or more memories that, when executing the instructions, perform the steps of:
performing a visual-language alignment operation based on a set of multi-view image features and a three-dimensional position encoding to generate a set of aligned image features,
causing a language model to generate a driving plan for operating the vehicle based on the set of aligned image features, wherein the driving plan includes a description of a three-dimensional trajectory for the vehicle, and
controlling the vehicle to move based on the driving plan.
